(19) United States
(12) Patent Application Publication
(10) Pub. No.: US 2016/0152002 A1
(43) Pub. Date: Jun. 2, 2016

(54) TRANSPARENT CONDUCTIVE LAMINATED FILM, METHOD FOR MANUFACTURING SAME, AND TOUCH PANEL

(71) Applicant: NITTO DENKO CORPORATION, Ibaraki-shi, Osaka (JP)

(72) Inventors: Kunihiro Inui, Ibaraki-shi (JP); Takeshi Saito, Ibaraki-shi (JP); Miki Okamoto, Ibaraki-shi (JP); Shinsuke Akizuki, Ibaraki-shi (JP)

(73) Assignee: NITTO DENKO CORPORATION, Ibaraki-shi, Osaka (JP)

(21) Appl. No.: 14/392,175

(22) PCT Filed: Oct. 17, 2013
(86) PCT No.: PCT/JP2013/078232

§ 371 Date: Dec. 23, 2015

(30) Foreign Application Priority Data
Jun. 24, 2013 (JP) 2013-131774

(51) Int. Cl. B32B 7/12; B32B 27/32; B32B 37/24; B32B 27/08; B32B 37/12; B32B 27/36; B32B 3/26

(52) U.S. Cl. CPC B32B 7/12; B32B 27/36; B32B 27/365; B32B 27/325; B32B 3/263; B32B 27/08; B32B 37/12; B32B 37/24; B32B 2255/26; B32B 2255/10; B32B 2307/202; B32B 2307/412; B32B 2457/208; B32B 2457/20; B32B 2037/1253; B32B 2037/243; B32B 38/0008

(57) ABSTRACT

A transparent conductive laminated film, comprising a laminated film comprising a plurality of transparent film substrates and a transparent cured adhesive layer having a storage modulus of 1×107 Pa or more at 140° C., wherein the plurality of transparent film substrates include a first transparent film substrate and a second transparent film substrate and are laminated with the transparent cured adhesive layer interposed between adjacent ones of the film substrates; and, a first transparent conductive layer provided on a surface of the first film substrate opposite to the transparent cured adhesive layer.

### TECHNICAL FIELD

The present invention relates to a transparent conductive laminated film including a first film substrate, a transparent conductive layer provided on one surface of the first film substrate, a transparent cured adhesive layer, and a second film substrate provided on the other surface of the first film substrate with the transparent cured adhesive layer interposed therebetween. The present invention also relates to a method for producing such a transparent conductive laminated film. The transparent conductive laminated film of the present invention can be used for a variety of electrode substrates, and is preferably used for an electrode substrate of an input device for capacitive touch panels. A touch panel having the transparent conductive laminated film of the present invention can be used for, for example, liquid crystal monitors, liquid crystal televisions, digital video cameras, digital cameras, cellular phones, portable game machines, car navigation systems, electronic papers, organic electroluminescent (EL) displays, and the like.

### BACKGROUND ART

A conventionally known transparent conductive film includes a transparent film substrate and a transparent conductive layer (such as an ITO coating) provided thereon. Such a transparent conductive layer is patterned when such a transparent conductive film is produced for use as an electrode substrate for capacitive touch panels (Patent Document 1). Such a transparent conductive laminated film having a patterned transparent conductive layer is used together with another transparent conductive film and other materials to form a laminate, which is advantageously used for a multi-touch input device capable of being operated with two or more fingers at the same time.

Transparent conductive films for use in capacitive touch panels and the like have various gaps between electrodes. In order to adapt such gaps, it is necessary to produce transparent conductive films with various thicknesses. However, the production of transparent conductive films with various thicknesses raises the problem of significantly low productivity. Thus, a transparent conductive laminated film is proposed, including a laminated film and a transparent conductive layer formed thereon, wherein the laminated film includes two or more films bonded for thickness control together with a thick pressure-sensitive adhesive layer (thick adhesive layer) with a thickness of about 20 μm.

### PRIOR ART DOCUMENT

### Patent Document

Patent Document 1: JP-A-2009-076432

### SUMMARY OF THE INVENTION

### Problems to be Solved by the Invention

However, there is a problem in that when the transparent conductive layer of the transparent conductive laminated film is patterned by etching to form a patterned transparent electrode, a large wavelike undulation can easily occur in the transparent conductive laminated film, so that the size of the parts with and without the patterned transparent electrode can be larger than the designed value.

It is an object of the present invention to provide a transparent conductive laminated film that includes a laminated film including first and second film substrates and can be prevented from undulating even when its transparent conductive layer is patterned, and to provide a method for producing such a transparent conductive laminated film.

It is another object of the present invention to provide a capacitive touch panel having such a transparent conductive laminated film.

### Means for Solving the Problems

As a result of intensive studies to solve the problems, the present inventors have made the transparent conductive laminated film described below and thus accomplished the present invention.

Specifically, the present invention is directed to a transparent conductive laminated film including: a laminated film including a plurality of transparent film substrates and a transparent cured adhesive layer having a storage modulus of 1×10⁷ Pa or more at 140° C., wherein the plurality of transparent film substrates include a first transparent film substrate and a second transparent film substrate and are laminated with the transparent cured adhesive layer interposed between adjacent ones of the film substrates; and a first transparent conductive layer provided on the surface of the first film substrate opposite to the transparent cured adhesive layer.

In the transparent conductive laminated film, there is preferably a difference in shrinkage rate of 0.3% or less between the transparent conductive laminated film and the laminated film after the film is heat-treated at 140° C. for 30 minutes.

In the transparent conductive laminated film, the transparent cured adhesive layer is preferably made from an active energy ray-curable adhesive composition including, as curable components, (A) a radically polymerizable compound with an SP value of 29.0 (kJ/m³)^{1/2} to 32.0 (kJ/m³)^{1/2}, (B) a radically polymerizable compound with an SP value of 18.0 (kJ/m³)^{1/2} to less than 21.0 (kJ/m³)^{1/2}, and (C) a radically polymerizable compound with an SP value of 21.0 (kJ/m³)^{1/2} to 23.0 (kJ/m³)^{1/2}, wherein the content of the radically polymerizable compound (B) is from 25 to 80% by weight based on 100% by weight of the total amount of the composition.

The active energy ray-curable adhesive composition may further include (D) an acrylic oligomer formed by polymerization of a (meth)acrylic monomer. The active energy ray-curable adhesive composition preferably contains 20% by weight or less of the acrylic oligomer (D) formed by polymerization of a (meth)acrylic monomer based on 100% by weight of the total amount of the composition.

The active energy ray-curable adhesive composition preferably contains 3 to 40% by weight of the radically polymerizable compound (A) and 5 to 55% by weight of the radically polymerizable compound (C) based on 100% by weight of the total amount of the composition.

The active energy ray-curable adhesive composition may include the radically polymerizable compounds (A), (B), and (C) in a total amount of 85 parts by weight or more and further include 15 parts by weight or less of (E) a radically polymerizable compound with an SP value of more than 23.0 (kJ/M³)^{1/2} to less than 29.0 (kJ/m³)^{1/2} based on 100 parts by weight of the total amount of the radically polymerizable compounds.

The active energy ray-curable adhesive composition preferably further includes (F) a radically polymerizable compound having an active methylene group and (G) a radical polymerization initiator having a hydrogen-withdrawing function. This feature can provide significantly improved adhesion for the adhesive layer of a polarizing film even immediately after the polarizing film is particularly taken out of a high-humidity environment or water (undried state). Although the reason for this is not clear, the following factors can be considered. The radically polymerizable compound (F) having an active methylene group can be polymerized together with other radically polymerizable compounds used to form the adhesive layer. During the polymerization for forming the adhesive layer, the radically polymerizable compound (F) having an active methylene group can be incorporated into the main chain and/or the side chain of the base polymer in the adhesive layer. When the radical polymerization initiator (G) having a hydrogen-withdrawing function is present in this polymerization process, hydrogen can be withdrawn from the radically polymerizable compound (F) having an active methylene group so that a radical can be generated on the methylene group in the process of forming the base polymer for the adhesive layer. The radical-carrying methylene group can react with hydroxyl groups in a polarizer made of PVA or the like, so that covalent bonds can be formed between the adhesive layer and the polarizer. This may result in a significant improvement in the adhesion of the adhesive layer of the polarizing film particularly even in an undried state.

In the active energy ray-curable adhesive composition, the active methylene group is preferably an acetoacetyl group.

In the active energy ray-curable adhesive composition, the radically polymerizable compound (F) having an active methylene group is preferably acetoacetoxyalkyl(meth)acrylate.

In the active energy ray-curable adhesive composition, the radical polymerization initiator (F) is preferably a thioxanthone radical polymerization initiator.

The active energy ray-curable adhesive composition preferably contains 1 to 50% by weight of the radically polymerizable compound (F) having an active methylene group and 0.1 to 10% by weight of the radical polymerization initiator (F) based on 100% by weight of the total amount of the composition.

The active energy ray-curable adhesive composition preferably further includes (H) a photo-acid generator.

In the active energy ray-curable adhesive composition, the photo-acid generator (H) preferably includes a photo-acid generator having at least one counter anion selected from the group consisting of PF₆⁻, SbF₆⁻, and AsF₆⁻.

The active energy ray-curable adhesive composition preferably further includes (I) a compound having either an alkoxy group or an epoxy group in addition to the photo-acid generator (H).

The active energy ray-curable adhesive composition preferably further includes (J) an amino group-containing silane coupling agent. With this feature, the resulting adhesive layer can have higher adhesion in warm water. The active energy ray-curable adhesive composition preferably contains 0.01 to 20% by weight of the amino group-containing silane coupling agent (J) based on 100% by weight of the total amount of the composition.

In the transparent conductive laminated film, the first film substrate preferably has a thickness of 15 μm to 75 μm.

In the transparent conductive laminated film, the transparent cured adhesive layer preferably has a thickness of 0.01 μm to 10 μm.

The transparent conductive laminated film may further include a second transparent conductive layer on the surface of the laminated film opposite to the first transparent conductive layer.

In the transparent conductive laminated film, the film substrates are preferably made of any one of a polyester resin, a cyclic polyolefin resin, or a polycarbonate resin.

In the transparent conductive laminated film, the transparent conductive layer is preferably made of any one of indium tin oxide or indium zinc oxide.

The transparent conductive laminated film is advantageous when the transparent conductive layer is crystallized.

The transparent conductive laminated film is advantageous when the transparent conductive layer is patterned.

The present invention is also directed to a touch panel including at least one piece of the transparent conductive laminated film.

The present invention is also directed to a method for producing the transparent conductive laminated film, the method including the steps of:

(a) preparing a transparent conductive film including a first film substrate and a first transparent conductive layer provided on one surface of the first film substrate;

(b) bonding a second film substrate to the other surface of the first film substrate with a transparent uncured adhesive layer, wherein the other surface of the first film substrate is opposite to the surface on which the first transparent conductive layer is provided, and the transparent uncured adhesive layer is capable of forming a transparent cured adhesive layer having a storage modulus of 1×10⁷ Pa or more at 140° C. when cured; and

(c) curing the transparent uncured adhesive layer.

The method for producing the transparent conductive laminated film may further include the step (d) of heat-treating the transparent conductive layer to crystallize the transparent conductive layer after the step (c).

The method for producing the transparent conductive laminated film may further include the step (e) of patterning the transparent conductive layer after the step (c).

In the method for producing the transparent conductive laminated film, the step (c) may include irradiating the transparent uncured adhesive layer with active energy rays to cure the transparent uncured adhesive layer, wherein the active energy rays may include visible rays with a wavelength in the range of 380 nm to 450 nm.

In the method for producing the transparent conductive laminated film, the active energy rays may be such that the ratio of the total illuminance in the wavelength range of 380 nm to 440 nm to the total illuminance in the wavelength range of 250 nm to 370 nm is from 100:0 to 100:50.

### Effect of the Invention

After the transparent conductive layer of a transparent conductive laminated film is patterned by etching, the transparent conductive laminated film is dried by heating. In this regard, it has been found that in the process of dying by heating after the etching, the transparent conductive laminated film can undulate due to a difference in shrinkage rate between the patterned and unpatterned parts of the film provided with the transparent conductive layer. In addition, to crystallize the transparent conductive layer, a heat treatment is performed on the transparent conductive laminated film. In this regard, it has also been found that in the cooling process after the heat treatment, a difference in shrinkage rate also occurs between the patterned and unpatterned parts of the transparent conductive laminated film. Finally, it has been found that during drying by heating, the elastic modulus of the pressure-sensitive adhesive layer or the adhesive layer used to laminate first and second film substrates in the transparent conductive laminated film is involved in the undulation phenomenon caused by the shrinkage rate difference.

In the transparent conductive laminated film of the present invention, the plurality of transparent film substrates including the first and second film substrates are laminated with the transparent cured adhesive layer having the specified storage modulus (1×10⁷ Pa or more) at 140° C., which corresponds to the temperature of drying by heating after the etching or other processes. Thanks to the adhesive layer, the shrinkage rate difference between the patterned and unpatterned parts of the transparent conductive laminated film of the present invention can be controlled to be small, so that the undulation phenomenon can be suppressed even when the transparent conductive layer is patterned and then subjected to drying by heating and other processes.

The transparent cured adhesive layer may be formed by curing the active energy ray-curable adhesive composition. In this case, the resulting adhesive layer can have a higher level of adhesion, durability, and water resistance between two or more members, specifically, between two or more film substrates. The transparent conductive laminated film according to the present invention also has the adhesive layer with a high level of adhesion, durability, and water resistance between the two or more film substrates.

The use of the adhesive layer according to the present invention makes it possible to produce transparent conductive laminated films resistant to dimensional changes. This makes it possible to easily address the production of large-sized transparent conductive laminated films and to reduce manufacturing costs in terms of yield or the number of available pieces.

### BRIEF DESCRIPTION OF THE DRAWINGS

FIG. 1 is a cross-sectional view showing an embodiment of the transparent conductive laminated film of the present invention.

FIG. 2 is a cross-sectional view showing an embodiment of the transparent conductive laminated film of the present invention.

FIG. 3 is a cross-sectional view showing an embodiment of the transparent conductive laminated film of the present invention.

FIG. 4 is a cross-sectional view showing an embodiment of the transparent conductive laminated film of the present invention.

### MODE FOR CARRYING OUT THE INVENTION

Embodiments of the transparent conductive laminated film of the present invention will be described below with reference to the drawings.

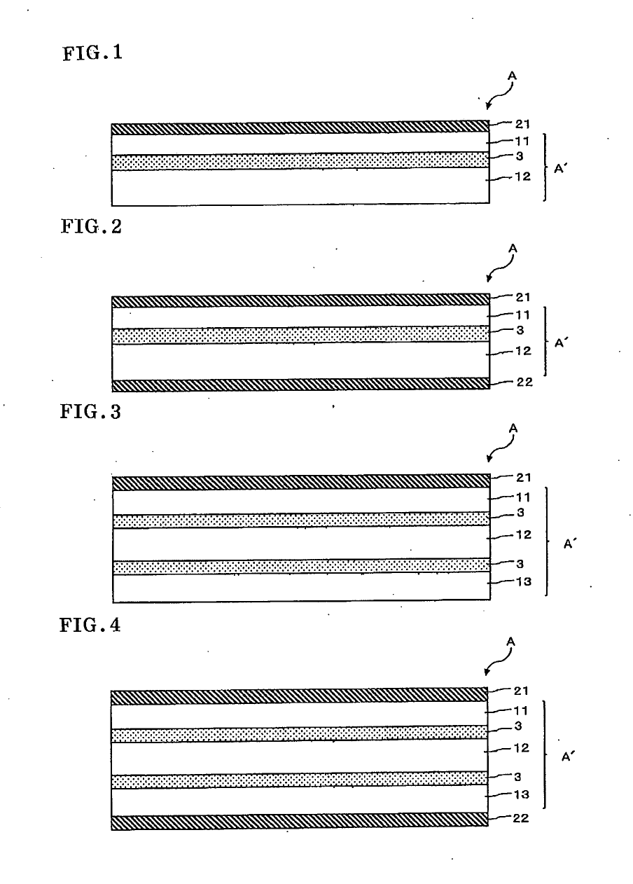

FIGS. 1 to 4 are cross-sectional views each showing an embodiment of the transparent conductive laminated film of the present invention. FIG. 1 shows a transparent conductive laminated film A including a first transparent film substrate 11, a first transparent conductive layer 21 provided on one surface of the first film substrate 11, a transparent cured adhesive layer 3 provided on the other surface of the first film substrate 11, and a second transparent film substrate 12 provided on the surface of the transparent cured adhesive layer 3 opposite to the first film substrate 11. In FIG. 2, a second transparent conductive layer 22 is further provided on the second film substrate 12 shown in FIG. 1. FIG. 3 shows a case where another transparent cured adhesive layer 3 and a third transparent film substrate 13 are further provided in this order on the second film substrate 12 of the transparent conductive laminated film A shown in FIG. 1. In FIG. 4, a second transparent conductive layer 22 is further provided on the third film substrate 13 shown in FIG. 3.

FIGS. 1 to 4 each also show a laminated film A′ together with the transparent conductive laminated film A. In the examples, the first transparent conductive layer 21 (and the second transparent conductive layer 22 in FIGS. 2 and 4) is removed by etching from the transparent conductive laminated film A, and the resulting laminated film A′ is measured for shrinkage rate. In FIGS. 1 to 4, the transparent conductive layers 21 and 22 are not patterned. Alternatively, at least one of the transparent conductive layers 21 and 22 may be patterned as appropriate.

In FIG. 1, the laminated film A includes the first and second film substrates 11 and 12 laminated with the transparent cured adhesive layer 3 interposed therebetween. In FIG. 2, the laminated film A includes the first, second, and third film substrates 11, 11, and 13 laminated in this order with each transparent cured adhesive layer 3 interposed between adjacent ones of them. Alternatively, the laminated film A may include four or more transparent film substrates laminated in order from the first film substrate with each transparent cured adhesive layer 3 interposed between adjacent ones of them. In the transparent conductive laminated film A of the present invention, the first transparent conductive layer 21 is provided on the surface of the first film substrate 21 of the laminated film A′ (in other words, the surface of the first film substrate 21 opposite to the transparent cured adhesive layer 3). In the laminated film A, the second transparent conductive layer 22 is provided on the surface opposite to the first transparent conductive layer 21.

In the present invention, the difference between the shrinkage rates of the transparent conductive laminated film A and the laminated film A′ is preferably controlled to 0.30% or less. Specifically, regardless of the presence or absence of the transparent conductive layer, the use of materials that provide no difference in shrinkage rate makes it possible to suppress undulation of a film obtained by patterning the transparent conductive laminated film A having a transparent conductive layer. The difference in shrinkage rate is preferably 0.15% or less, more preferably 0.10% or less. In this regard, the shrinkage rate is the value measured as described in the Examples section

The first and second film substrates and other film substrates may be any of various transparent plastic films. Examples of materials for the substrates include polyester resins such as polyethylene terephthalate and polyethylene naphthalate, acetate resins, polyethersulfone resins, polycarbonate resins, polyamide resins, polyimide resins, polyethylene, polypropylene, cyclo- or norbornene-structure-containing polyolefin resins, (meth)acrylic resins, polyvinyl chloride resins, polyvinylidene chloride resins, polystyrene resins, polyvinyl alcohol resins, polyarylate resins, and polyphenylene sulfide resins. Among them, polyethylene terephthalate, polycarbonate resins, and cyclo- or norbornene-structure-containing cyclic polyolefin resins are particularly preferred.

The same or different materials may be used to form the first and second film substrates and other film substrates. In order to suppress undulation, the same material is preferably used to form the film substrates.

The first film substrate, on which the first transparent conductive layer is to be formed, preferably has a thickness of 15 to 75 μm in view of productivity. Its thickness is more preferably from 15 to 60 μm, even more preferably from 20 to 50 μm. The first film substrate with a thickness below the range may have an insufficient strength and be difficult to handle. On the other hand, if the first film substrate is too thick, it may take a long time to perform degassing under vacuum, for example, in the process of forming the transparent conductive layer by sputtering, and a roll of the same material with a shorter length must be used, so that the material roll replacement may be time-consuming, which is not preferred in view of productivity.

Transparent conductive films for use in capacitive touch panels have a variety of gaps between electrodes. In order to adapt to such gaps, the second film substrate preferably has a thickness of 30 to 200 μm. Its thickness is more preferably from 50 to 175 μm, even more preferably from 75 to 175 μm. If the second film substrate is too thick, the transparency may decrease, and the laminated film may be difficult to install, for example, in a touch panel. The thickness (t2) of the second film substrate preferably satisfies (t2/t1)=1.5 to 6 in relation to the thickness (t1) of the first film substrate, so that the shrinkage of the first and second film substrates under heating can be reduced and thus undulation can be suppressed.

The thickness of the third film substrate and other additional film substrates may be appropriately determined depending on how the laminated film will be used. In general, the thickness of the third film substrate and other additional film substrates may be in the range of the thickness of the first or second film substrate.

The surface of the film substrate such as the first or second film substrate may be previously subjected to sputtering, corona discharge treatment, flame treatment, ultraviolet irradiation, electron beam irradiation, chemical treatment, etching treatment such as oxidation, or undercoating treatment. As a result, the transparent conductive layer or the undercoat layer (described below) provided on the treated surface can have improved adhesion to the first, second, or any additional film substrate. Before the transparent conductive layer or the undercoat layer is formed, if necessary, the first or second film substrate may be subjected to solvent washing or ultrasonic washing for removal of dust and cleaning.

As a non-limiting example, the material used to form the transparent conductive layer may be an oxide of at least one metal selected from the group consisting of indium, tin, zinc, gallium, antimony, titanium, silicon, zirconium, magnesium, aluminum, gold, silver, copper, palladium, and tungsten. If necessary, the metal oxide may further contain any other metal atom selected from the group. For example, indium tin oxide (indium oxide-tin oxide complex oxide), indium zinc oxide (indium oxide-zinc oxide complex oxide), antimony-doped tin oxide, or the like is preferably used.

The thickness of the transparent conductive layer is preferably, but not limited to, 10 nm or more, more preferably 15 to 40 nm, even more preferably 20 to 30 nm. The transparent conductive layer 21 or 22 with a thickness of 15 nm or more can easily have an appropriate level of surface resistance not more than 1×10³ Ω/square, and can be easily formed as a continuous coating. The transparent conductive layer 2 with a thickness of 40 nm or less can have a higher level of transparency. When the laminated film has first and second transparent conductive layers as shown in FIG. 2 or 4, the two transparent conductive layers may have the same or different thicknesses. The two transparent conductive layers may be made of the same or different materials.

The transparent conductive layer may be formed by any conventionally known method. Examples include vacuum deposition, sputtering, and ion plating. Any appropriate method may also be used depending on the desired thickness.

The transparent conductive layer may be patterned by etching. Various patterns may be formed depending on the intended use of the transparent conductive laminated film, which can be provided in various modes. When patterned, the transparent conductive layer can have a patterned part and an unpatterned part. The patterned part may be, for example, stripe-shaped, square-shaped, or the like.

The transparent cured adhesive layer is used to bond film substrates such as the first and second film substrates. The transparent cured adhesive layer has a storage modulus of 1×10⁷ Pa or more at 140° C. Using the transparent cured adhesive layer with such a level of storage modulus, the difference in shrinkage rate between the transparent conductive laminated film A and the laminated film including the first and second film substrates can be controlled to a lower level, so that undulation can be suppressed even when the transparent conductive layer of the transparent conductive laminated film A is etched and then dried by heating. When three or more film substrates are used as shown in FIG. 3 or 4, the transparent conductive laminated film A has two or more transparent cured adhesive layers, in which all the transparent cured adhesive layers should satisfy the level of storage modulus mentioned above. The storage modulus of the transparent cured adhesive layer is preferably 3.0×10⁷ Pa or more, more preferably 4.0×10⁷ Pa or more. With a storage modulus of less than 1×10⁷, the transparent cured adhesive layer cannot reduce undulation sufficiently. On the other hand, the storage modulus of the transparent cured adhesive layer is preferably 1.0×10¹⁰ Pa or less. With a storage modulus of more than 1.0×10¹⁰ Pa, the adhesive layer may have lower adhesive properties.

The transparent cured adhesive layer is formed by curing a curable adhesive containing a curable component. The curable component may be, for example, a radically polymerizable compound or an ionically polymerizable compound such as a cationically polymerizable compound or an anionically polymerizable compound. The transparent cured adhesive layer can be formed by irradiating the curable component-containing curable adhesive with active energy rays. The curable adhesive may also contain a base polymer and an oligomer as needed in addition to the curable component (such as the radically polymerizable compound). The storage modulus can be adjusted by controlling the type and content of the curable component (such as the radically polymerizable compound) and the type and content of the base polymer and other components. An active energy ray-curable adhesive containing a radically polymerizable compound is preferably used as the curable adhesive capable of forming the transparent cured adhesive layer according to the present invention.

The radically polymerizable compound may be a (meth)acryloyl group-containing compound or a vinyl group-containing compound. Any of these radically polymerizable compounds may be monofunctional or di- or polyfunctional. These radically polymerizable compounds are preferably (meth)acryloyl group-containing compounds. As used herein, the term “(meth)acryloyl group” means an acryloyl group and/or a methacryloyl group. In the present invention, “(meth)” is used in the same meaning.

The transparent cured adhesive layer that satisfies the above level of storage modulus can be made from, for example, an active energy ray-curable adhesive composition including (A) a radically polymerizable compound with an SP value of 29.0 (kJ/m³)^{1/2} to 32.0 (kJ/m³)^{1/2} (B) a radically polymerizable compound with an SP value of 18.0 (kJ/m³)^{1/2} to less than 21.0 (kJ/m³)^{1/2}, and (C) a radically polymerizable compound with an SP value of 21.0 (kJ/m³)^{1/2} to 23.0 (kJ/m³)^{1/2}, in which the content of the radically polymerizable compound (B) is from 25 to 80% by weight based on 100% by weight of the total amount of the composition. As used herein, the term “the total amount of the composition” means the amount of all the components, which may include not only the radically polymerizable compounds but also any of various initiators and additives.

The content of the radically polymerizable compound (B), which has an SP value of 18.0 (kJ/m³)^{1/2} to less than 21.0 (kJ/m³)^{1/2}, is preferably from 25 to 80% by weight. The radically polymerizable compound (B), which has a relatively low SP value significantly different from that of water (47.9 in SP value), can significantly contribute to the improvement of the water resistance of the transparent cured adhesive layer. The radically polymerizable compound (B) can also contribute to the improvement of the storage modulus when it is a polyfunctional radically polymerizable compound. In addition, the SP value of the radically polymerizable compound (B) is close to the SP value of a cyclic polyolefin resin (e.g., ZEONOR (trade name) manufactured by ZEON CORPORATION) (e.g., with an SP value of 18.6) for the first or second film substrate. Therefore, the radically polymerizable compound (B) can also contribute to the improvement of adhesion to the first or second film substrate. Particularly in view of the water resistance of the transparent cured adhesive layer, the content of the radically polymerizable compound (B) is preferably 30% by weight or more, more preferably 40% by weight or more, based on 100% by weight of the total amount of the composition. On the other hand, if the content of the radically polymerizable compound (B) is too high, the content of the radically polymerizable compounds (A) and (C) must be low, so that the adhesion to the film substrate such as the first or second film substrate will tend to decrease. In addition, the radically polymerizable compound (B) has an SP value significantly different from that of the radically polymerizable compound (A). Therefore, if the content of the radically polymerizable compound (B) is too high, the compatibility balance between the radically polymerizable compounds can degrade, so that the transparency of the adhesive layer may decrease as phase separation proceeds. In view of the transparency of the transparent cured adhesive layer and the adhesion to the film substrate such as the first or second film substrate, therefore, the content of the radically polymerizable compound (B) is preferably 75% by weight or less, more preferably 70% by weight or less, based on 100% by weight of the total amount of the composition.

In the active energy ray-curable adhesive composition, the radically polymerizable compound (A) has an SP value of 29.0 (kJ/m³)^{1/2} to 32.0 (kJ/m³)^{1/2}. The radically polymerizable compound (A) has a relatively high SP value and thus can significantly contribute to the improvement of the adhesion between the transparent cured adhesive layer and the film substrate such as the first or second film substrate. Particularly in view of the adhesion between the transparent cured adhesive layer and the film substrate such as the first or second film substrate, the content of the radically polymerizable compound (A) is preferably 3% by weight or more, more preferably 5% by weight or more, based on 100% by weight of the total amount of the composition. On the other hand, the radically polymerizable compound (A) can have low compatibility with the acrylic oligomer (D) formed by polymerization of a (meth)acrylic monomer, and may form a nonuniform transparent cured adhesive layer after curing if phase separation proceeds. Thus, to ensure the uniformity and transparency of the transparent cured adhesive layer, the content of the radically polymerizable compound (A) is preferably 40% by weight or less, more preferably 30% by weight or less, based on 100% by weight of the total amount of the composition.

The radically polymerizable compound (C) has an SP value of 21.0 (kJ/m³)^{1/2} to less than 23.0 (kJ/m³)^{1/2}. As mentioned above, the radically polymerizable compounds (A) and (B) have significantly different SP values and thus can have low compatibility with each other. However, the radically polymerizable compound (C) has an SP value between those of the radically polymerizable compounds (A) and (B), and thus the use of the radically polymerizable compounds (A) and (B) in combination with the radically polymerizable compound (C) can improve the compatibility between all components of the composition in a well-balanced manner. In addition, the radically polymerizable compound (C) can also contribute to the improvement of adhesion to the film substrate such as the first or second film substrate. Thus, in order to improve water resistance and adhesion in a well-balanced manner, the content of the radically polymerizable compound (C) is preferably from 5 to 55% by weight. In view of the compatibility between all components of the composition and the adhesion to the film substrate such as the first or second film substrate, the content of the radically polymerizable compound (C) is more preferably 10% by weight or more. In view of water resistance, the content of the radically polymerizable compound (C) is more preferably 30% by weight or less.

Hereinafter, a method for calculating the SP value (solubility parameter) in the present invention will be described.

(Method for Calculating the Solubility Parameter (SP Value))

In the present invention, the solubility parameters (SP values) of the radically polymerizable compounds and other components can be calculated using the Fedors method (see Polymer Eng. & Sci., Vol. 14, No. 2 (1974), pp. 148-154). Specifically, it can be calculated from the following formula:

$$δ = {[ \frac{{\sum }_{i} Δ e i}{{\sum }_{i} Δ v i} ]}^{1 / 2} \qquad [ Formula 1 ]$$

wherein Δei is the evaporation energy of an atom or group at 25° C., and Δvi is its molar volume at 25° C.

In the formula, constant values for each of i atoms and groups in the main molecule are substituted for Δei and Δvi. Table 1 below shows Δe and Δv values for typical atoms or groups.

TABLE 1

| Atom or group | Δe (J/mol) | Δv (cm³/mol) |
|---|---|---|
| CH₃ | 4086 | 33.5 |
| C | 1465 | −19.2 |
| Phenyl | 31940 | 71.4 |
| Phenylene | 31940 | 52.4 |
| COOH | 27628 | 28.5 |
| CONH₂ | 41861 | 17.5 |
| NH₂ | 12558 | 19.2 |
| —N═ | 11721 | 5.0 |
| CN | 25535 | 24.0 |
| NO₂ (fatty acid) | 29302 | 24.0 |
| NO₃ (aromatic) | 15363 | 32.0 |
| O | 3349 | 3.8 |
| OH | 29805 | 10.0 |
| S | 14149 | 12.0 |
| F | 4186 | 18.0 |
| Cl | 11553 | 24.0 |
| Br | 15488 | 30.0 |

The radically polymerizable compound (A) may be any compound having a radically polymerizable group such as a (meth)acryloyl group and having an SP value of 29.0 (kJ/m³)^{1/2} to 32.0 (kJ/m³)^{1/2}. Examples of the radically polymerizable compound (A) include hydroxyethylacrylamide (29.6 in SP value) and N-methylolacrylamide (31.5 in SP value).

The radically polymerizable compound (B) may be any compound having a radically polymerizable group such as a (meth)acryloyl group and having an SP value of 18.0 (kJ/m³)^{1/2} to less than 21.0 (kJ/m³)^{1/2}. Examples of the radically polymerizable compound (B) include tripropylene glycol diacrylate (19.0 in SP value), 1,9-nonanediol diacrylate (19.2 in SP value), tricyclodecane dimethanol diacrylate (20.3 in SP value), cyclic trimethylolpropane formal acrylate (19.1 in SP value), dioxane glycol diacrylate (19.4 in SP value), and EO-modified diglycerol tetraacrylate (20.9 in SP value). The radically polymerizable compound (B) may be advantageously a commercially available product, examples of which include Aronix M-220 (manufactured by Toagosei Co., Ltd., 19.0 in SP value), LIGHT ACRYLATE 1,9ND-A (manufactured by Kyoeisha Chemical Co., Ltd., 19.2 in SP value), LIGHT ACRYLATE DGE-4A (manufactured by Kyoeisha Chemical Co., Ltd., 20.9 in SP value), LIGHT ACRYLATE DCP-A (manufactured by Kyoeisha Chemical Co., Ltd., 20.3 in SP value), SR-531 (manufactured by Sartomer, 19.1 in SP value), and CD-536 (manufactured by Sartomer, 19.4 in SP value).

The radically polymerizable compound (C) may be any compound having a radically polymerizable group such as a (meth)acryloyl group and having an SP value of 21.0 (kJ/m³)^{1/2} to 23.0 (kJ/m³)^{1/2}. Examples of the radically polymerizable compound (C) include acryloylmorpholine (22.9 in SP value), N-methoxymethylacrylamide (22.9 in SP value), and N-ethoxymethylacrylamide (22.3 in SP value). The radically polymerizable compound (C) may be advantageously a commercially available product, examples of which include ACMO (manufactured by KOHJIN Film E. Chemicals Co., Ltd., 22.9 in SP value), WASMER 2MA (manufactured by Kasano Kosan Co., Ltd., 22.9 in SP value), WASMER EMA (manufactured by Kasano Kosan Co., Ltd., 22.3 in SP value), and WASMER 3MA (manufactured by Kasano Kosan Co., Ltd., 22.4 in SP value).

The active energy ray-curable adhesive composition may contain the radically polymerizable compounds (A), (B), and (C) in a total amount of 85 parts by weight or more and may further contain 15 parts by weight or less of (E) a radically polymerizable compound with an SP value of more than 23.0 (kJ/m³)^{1/2} to less than 29.0 (kJ/m³)^{1/2} based on 100 parts by weight of the total amount of the radically polymerizable compounds in the active energy ray-curable adhesive composition. According to these features, the adhesive composition can have satisfactory contents of the radically polymerizable compounds (A), (B) and (C), so that the resulting transparent cured adhesive layer can have a higher level of adhesion, durability, and water resistance. For the purpose of further improving adhesion, durability, and water resistance in a well-balanced manner, the total amount of the radically polymerizable compounds (A), (B) and (C) is preferably from 90 to 100 parts by weight, more preferably from 95 to 100 parts by weight. The amount of the radically polymerizable compound (E) is preferably 10 parts by weight or less, more preferably 5 parts by weight or less.

Examples of the radically polymerizable compound (E) include 4-hydroxybutyl acrylate (23.8 in SP value), 2-hydroxyethyl acrylate (25.5 in SP value), N-vinylcaprolactam (V-CAP (trade name) manufactured by ISP Investments Inc., 23.4 in SP value), and 2-hydroxypropyl acrylate (24.5 in SP value).

The active energy ray-curable adhesive composition may contain (D) an acrylic oligomer, which is formed by polymerization of a (meth)acrylic monomer, in addition to the radically polymerizable compounds (A), (B), (C), and (E) as curable components. The component (D) in the active energy ray-curable adhesive composition can reduce curing shrinkage in the process of irradiating and curing the composition with active energy rays and reduce the interface stress between the adhesive and the film substrate such as the first or second film substrate. This makes it possible to suppress the reduction in the adhesion between the transparent cured adhesive layer and the adherend. The adhesive composition preferably contains 20% by weight or less of the acrylic oligomer (D). In order to sufficiently suppress the curing shrinkage of the transparent cured adhesive layer, the adhesive composition preferably contains 3% by weight or more, more preferably 5% by weight or more of the acrylic oligomer (D). On the other hand, if the content of the acrylic oligomer (D) in the adhesive composition is too high, a sharp reduction in reaction rate may occur to cause insufficient curing when the composition is irradiated with active energy rays. Therefore, the content of the acrylic oligomer (D) in the adhesive composition is preferably 20% by weight or less, more preferably 15% by weight or less.

In view of workability or uniformity during coating, the active energy ray-curable adhesive composition preferably has low viscosity. Therefore, the acrylic oligomer (D) formed by polymerization of a (meth)acrylic monomer also preferably has low viscosity. The acrylic oligomer that has low viscosity and can prevent curing shrinkage of the transparent cured adhesive layer preferably has a weight average molecular weight (Mw) of 15,000 or less, more preferably 10,000 or less, even more preferably 5,000 or less. On the other hand, to suppress curing shrinkage of the transparent cured adhesive layer sufficiently, the acrylic oligomer (D) preferably has a weight average molecular weight (Mw) of 500 or more, more preferably 1,000 or more, even more preferably 1,500 or more. Examples of the (meth)acrylic monomer used to form the acrylic oligomer (D) include (C1 to C20) alkyl(meth)acrylates such as methyl(meth)acrylate, ethyl(meth)acrylate, n-propyl(meth)acrylate, isopropyl(meth)acrylate, 2-methyl-2-nitropropyl(meth)acrylate, n-butyl(meth)acrylate, isobutyl(meth)acrylate, sec-butyl(meth)acrylate, tert-butyl(meth)acrylate, n-pentyl(meth)acrylate, tert-pentyl(meth)acrylate, 3-pentyl(meth)acrylate, 2,2-dimethylbutyl(meth)acrylate, n-hexyl(meth)acrylate, cetyl(meth)acrylate, n-octyl(meth)acrylate, 2-ethylhexyl(meth)acrylate, 4-methyl-2-propylpentyl(meth)acrylate, and n-octadecyl(meth)acrylate; cycloalkyl(meth)acrylates (e.g., cyclohexyl(meth)acrylate and cyclopentyl(meth)acrylate); aralkyl(meth)acrylates (e.g., benzyl(meth)acrylate); polycyclic(meth)acrylates (e.g., 2-isobornyl(meth)acrylate, 2-norbornylmethyl(meth)acrylate, 5-norbornen-2-yl-methyl(meth)acrylate, and 3-methyl-2-norbornylmethyl(meth)acrylate); hydroxyl group-containing (meth)acrylates (e.g., hydroxyethyl(meth)acrylate, 2-hydroxypropyl(meth)acrylate, and 2,3-dihydroxypropylmethyl-butyl(meth)acrylate); alkoxy group- or phenoxy group-containing (meth)acrylates (e.g., 2-methoxyethyl(meth)acrylate, 2-ethoxyethyl(meth)acrylate, 2-methoxymethoxyethyl(meth)acrylate, 3-methoxybutyl(meth)acrylate, ethylcarbitol(meth)acrylate, and phenoxyethyl(meth)acrylate); epoxy group-containing (meth)acrylates (e.g., glycidyl(meth)acrylate); halogen-containing (meth)acrylates (e.g., 2,2,2-trifluoroethyl(meth)acrylate, 2,2,2-trifluoroethylethyl(meth)acrylate, tetrafluoropropyl(meth)acrylate, hexafluoropropyl(meth)acrylate, octafluoropentyl(meth)acrylate, and heptadecafluorodecyl(meth)acrylate); and alkylaminoalkyl(meth)acrylates (e.g., dimethylaminoethyl(meth)acrylate). These (meth)acrylates may be used singly or in combination of two or more. Examples of the acrylic oligomer (D) include ARUFON manufactured by Toagosei Co., Ltd., Actflow manufactured by Soken Chemical & Engineering Co., Ltd., and JONCRYL manufactured by BASF Japan Ltd.

The active energy ray-curable adhesive composition preferably further contains (F) a radically polymerizable compound having an active methylene group and (G) a radical polymerization initiator having a hydrogen-withdrawing function.

The radically polymerizable compound (F) having an active methylene group should be a compound having an active double-bond group such as a (meth)acrylic group at its end or in its molecule and also having an active methylene group. The active methylene group may be, for example, an acetoacetyl group, an alkoxymalonyl group, or a cyanoacetyl group. Examples of the radically polymerizable compound (F) having an active methylene group include acetoacetoxyalkyl(meth)acrylates such as 2-acetoacetoxyethyl(meth)acrylate, 2-acetoacetoxypropyl(meth)acrylate, and 2-acetoacetoxy-1-methylethyl(meth)acrylate; 2-ethoxymalonyloxyethyl(meth)acrylate, 2-cyanoacetoxyethyl(meth)acrylate, N-(2-cyanoacetoxyethyl)acrylamide, N-(2-propionylacetoxybutyl)acrylamide, N-(4-acetoacetoxymethylbenzyl)acrylamide, and N-(2-acetoacetylaminoethyl)acrylamide. The radically polymerizable compound (F) having an active methylene group may have any SP value.

In the present invention, the radical polymerization initiator (G) having a hydrogen-withdrawing function may be, for example, a thioxanthone radical polymerization initiator or a benzophenone radical polymerization initiator. The thioxanthone radical polymerization initiator may be, for example, the compound of formula (1) shown above. Examples of the compound of formula (1) include thioxanthone, dimethyl thioxanthone, diethyl thioxanthone, isopropyl thioxanthone, and chlorothioxanthone. In particular, the compound of formula (1) is preferably diethyl thioxanthone in which R¹ and R² are each —CH₂CH₃.

In the present invention, as mentioned above, the reaction of the radically polymerizable compound (F) having an active methylene group in the presence of the radical polymerization initiator (G) having a hydrogen-withdrawing function produces a radical on the methylene group, which reacts with the hydroxyl group in a polarizer made of PVA or the like to form a covalent bond. Thus, in order to produce a radical on the methylene group of the radically polymerizable compound (F) having an active methylene group so that the covalent bond can be sufficiently formed, the composition preferably contains 1 to 50% by weight of the radically polymerizable compound (F) having an active methylene group and 0.1 to 10% by weight of the radical polymerization initiator (G), and more preferably contains 3 to 30% by weight of the radically polymerizable compound (F) having an active methylene group and 0.3 to 9% by weight of the radical polymerization initiator (G), based on 100% by weight of the total amount of the composition. If the content of the radically polymerizable compound (F) having an active methylene group is less than 1% by weight, the effect of increasing the adhesion in an undried state can be low, and water resistance may fail to improve sufficiently. If it is more than 50% by weight, the adhesive layer may be insufficiently cured. If the content of the radical polymerization initiator (G) having a hydrogen-withdrawing function is less than 0.1% by weight, the hydrogen-withdrawing reaction may fail to proceed sufficiently. If it is more than 10% by weight, the initiator (G) may fail to dissolve completely in the composition.

In the present invention, the active energy ray-curable resin composition may contain a photo-acid generator. In this case, the resulting adhesive layer can have a dramatically higher level of water resistance and durability than that in the case where the composition contains no photo-acid generator. The photo-acid generator (H) may be represented by formula (3) below.

Formula (3):

L⁺X⁻ [Chemical formula 1]

wherein L⁺ represents any onium cation, and X⁻ represents a counter anion selected from the group consisting of PF₆⁻, SbF₆⁻, AsF₆⁻, SbCl₆⁻, BiCl₅⁻, SnCl₆⁻, ClO₄⁻, dithiocarbamate anion, and SCN⁻.

A preferred onium cation structure of the onium cation L⁺ in formula (3) is selected from those of formulae (4) to (12) below.

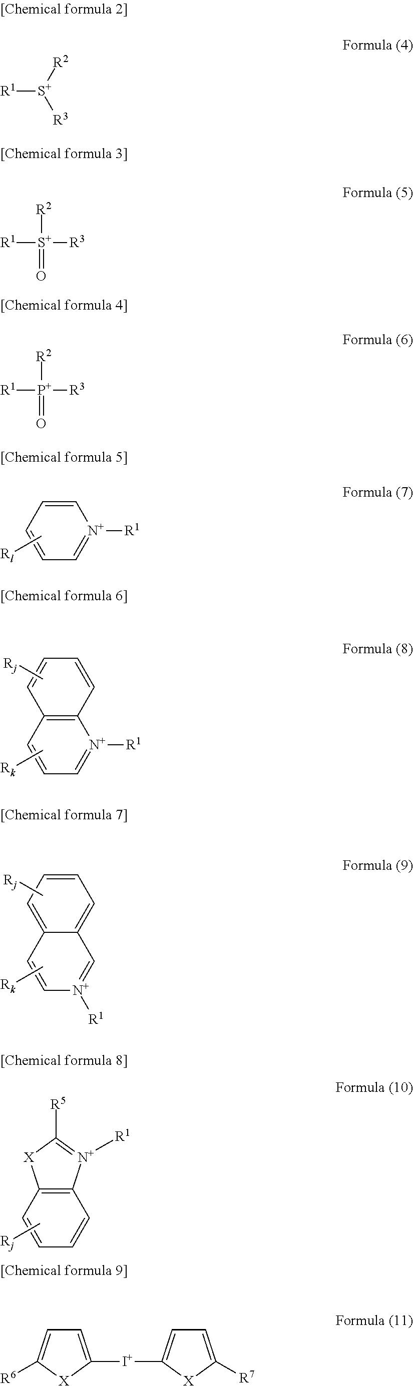

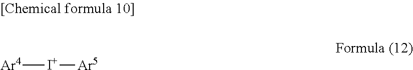

In Formulae (4) to (12), R¹, R², and R³ each independently represent a group selected from a hydrogen atom, a substituted or unsubstituted alkyl group, a substituted or unsubstituted alkenyl group, a substituted or unsubstituted aryl group, a substituted or unsubstituted heterocyclic group, a substituted or unsubstituted alkoxyl group, a substituted or unsubstituted aryloxy group, a substituted or unsubstituted heterocyclic oxy group, a substituted or unsubstituted acyl group, a substituted or unsubstituted carbonyloxy group, a substituted or unsubstituted oxycarbonyl group, or a halogen atom, R⁴ has the same meaning as defined for R¹, R², and R³, R⁵ represents a substituted or unsubstituted alkyl group or a substituted or unsubstituted alkylthio group, R⁶ and R⁷ each independently represent a substituted or unsubstituted alkyl group or a substituted or unsubstituted alkoxyl group, R represents a halogen atom, a hydroxyl group, a carboxyl group, a mercapto group, a cyano group, a nitro group, a substituted or unsubstituted carbamoyl group, a substituted or unsubstituted alkyl group, a substituted or unsubstituted alkenyl group, a substituted or unsubstituted aryl group, a substituted or unsubstituted heterocyclic group, a substituted or unsubstituted alkoxyl group, a substituted or unsubstituted aryloxy group, a substituted or unsubstituted heterocyclic oxy group, a substituted or unsubstituted alkylthio group, a substituted or unsubstituted arylthio group, a substituted or unsubstituted heterocyclic thio group, a substituted or unsubstituted acyl group, a substituted or unsubstituted carbonyloxy group, or a substituted or unsubstituted oxycarbonyl group, Ar⁴ and Ar⁵ each represent a substituted or unsubstituted aryl group or a substituted or unsubstituted heterocyclic group, X represents an oxygen or sulfur atom, i represents an integer of 0 to 5, j represents an integer of 0 to 4, k represents an integer of 0 to 3, and adjacent R moieties, Ar⁴ and Ar⁵, R² and R³, R² and R⁴, R³ and R⁴, R¹ and R², R¹ and R³, R¹ and R⁴, R¹ and R, or R¹ and R⁵ may be linked together to form a cyclic structure.

Examples of the onium cation (sulfonium cation) corresponding to formula (4) include, but are not limited to, dimethyl phenyl sulfonium, dimethyl(o-fluorophenyl)sulfonium, dimethyl(m-chlorophenyl)sulfonium, dimethyl(p-bromophenyl)sulfonium, dimethyl(p-cyanophenyl)sulfonium, dimethyl(m-nitrophenyl)sulfonium, dimethyl(2,4,6-tribromophenyl)sulfonium, dimethyl(pentafluorophenyl)sulfonium, dimethyl(p-(trifluoromethyl)phenyl)sulfonium, dimethyl(p-hydroxyphenyl)sulfonium, dimethyl(p-mercaptophenyl)sulfonium, dimethyl(p-methylsulfinylphenyl)sulfonium, dimethyl(p-methylsulfonylphenyl)sulfonium, dimethyl(o-acetylphenyl)sulfonium, dimethyl(o-benzoylphenyl)sulfonium, dimethyl(p-methylphenyl)sulfonium, dimethyl(p-isopropylphenyl)sulfonium, dimethyl(p-octadecylphenyl)sulfonium, dimethyl(p-cyclohexylphenyl)sulfonium, dimethyl(p-methoxyphenyl)sulfonium, dimethyl(o-methoxycarbonylphenyl)sulfonium, dimethyl(p-phenylsulfanylphenyl)sulfonium, (7-methoxy-2-oxo-2H-chromen-4-yl)dimethyl sulfonium, (4-methoxynaphthalene-1-yl)dimethyl sulfonium, dimethyl(p-isopropoxycarbonylphenyl)sulfonium, dimethyl(2-naphthyl)sulfonium, dimethyl(9-anthryl)sulfonium, diethyl phenyl sulfonium, methyl ethyl phenyl sulfonium, methyl diphenyl sulfonium, triphenyl sulfonium, diisopropyl phenyl sulfonium, diphenyl(4-phenylsulfanyl-phenyl)-sulfonium, 4,4′-bis(diphenyl sulfonium)diphenyl sulfide, 4,4′-bis[di[(4-(2-hydroxy-ethoxy)-phenyl)]sulfonium]]diphenyl sulfide, 4,4′-bis(diphenyl sulfonium)biphenylene, diphenyl(o-fluorophenyl)sulfonium, diphenyl(m-chlorophenyl)sulfonium, diphenyl(p-bromophenyl)sulfonium, diphenyl(p-cyanophenyl)sulfonium, diphenyl(m-nitrophenyl)sulfonium, diphenyl(2,4,6-tribromophenyl)sulfonium, diphenyl(pentafluorophenyl)sulfonium, diphenyl(p-(trifluoromethyl)phenyl)sulfonium, diphenyl(p-hydroxyphenyl)sulfonium, diphenyl(p-mercaptophenyl)sulfonium, diphenyl(p-methylsulfinylphenyl)sulfonium, diphenyl(p-methylsulfonylphenyl)sulfonium, diphenyl(o-acetylphenyl)sulfonium, diphenyl(o-benzoylphenyl)sulfonium, diphenyl(p-methylphenyl)sulfonium, diphenyl(p-isopropylphenyl)sulfonium, diphenyl(p-octadecylphenyl)sulfonium, diphenyl(p-cyclohexylphenyl)sulfonium, diphenyl(p-methoxyphenyl)sulfonium, diphenyl(o-methoxycarbonylphenyl)sulfonium, diphenyl(p-phenylsulfanylphenyl)sulfonium, (7-methoxy-2-oxo-2H-chromen-4-yl)diphenyl sulfonium, (4-methoxynaphthalene-1-yl)diphenyl sulfonium, diphenyl(p-isopropoxycarbonylphenyl)sulfonium, diphenyl(2-naphthyl)sulfonium, diphenyl(9-anthryl)sulfonium, ethyl diphenyl sulfonium, methyl ethyl(o-tolyl)sulfonium, methyl di(p-tolyl)sulfonium, tri(p-tolyl)sulfonium, diisopropyl(4-phenylsulfanylphenyl)sulfonium, diphenyl(2-thienyl)sulfonium, diphenyl(2-furyl)sulfonium, and diphenyl(9-ethyl-9H-carbazol-3-yl)sulfonium.

Examples of the onium cation (sulfoxonium cation) corresponding to formula (5) include, but are not limited to, dimethyl phenyl sulfoxonium, dimethyl(o-fluorophenyl)sulfoxonium, dimethyl(m-chlorophenyl)sulfoxonium, dimethyl(p-bromophenyl)sulfoxonium, dimethyl(p-cyanophenyl)sulfoxonium, dimethyl(m-nitrophenyl)sulfoxonium, dimethyl(2,4,6-tribromophenyl)sulfoxonium, dimethyl(pentafluorophenyl)sulfoxonium, dimethyl(p-(trifluoromethyl)phenyl)sulfoxonium, dimethyl(p-hydroxyphenyl)sulfoxonium, dimethyl(p-mercaptophenyl)sulfoxonium, dimethyl(p-methylsulfinylphenyl)sulfoxonium, dimethyl(p-methylsulfonylphenyl)sulfoxonium, dimethyl(o-acetylphenyl)sulfoxonium, dimethyl(o-benzoylphenyl)sulfoxonium, dimethyl(p-methylphenyl)sulfoxonium, dimethyl(p-isopropylphenyl)sulfoxonium, dimethyl(p-octadecylphenyl)sulfoxonium, dimethyl(p-cyclohexylphenyl)sulfoxonium, dimethyl(p-methoxyphenyl)sulfoxonium, dimethyl(o-methoxycarbonylphenyl)sulfoxonium, dimethyl(p-phenylsulfanylphenyl)sulfoxonium, (7-methoxy-2-oxo-2H-chromen-4-yl)dimethyl sulfoxonium, (4-methoxynaphthalene-1-yl)dimethyl sulfoxonium, dimethyl(p-isopropoxycarbonylphenyl)sulfoxonium, dimethyl(2-naphthyl)sulfoxonium, dimethyl(9-anthryl)sulfoxonium, diethyl phenyl sulfoxonium, methyl ethyl phenyl sulfoxonium, methyl diphenyl sulfoxonium, triphenyl sulfoxonium, diisopropyl phenyl sulfoxonium, diphenyl(4-phenylsulfanyl-phenyl)-sulfoxonium, 4,4′-bis(diphenyl sulfoxonium)diphenyl sulfide, 4,4′-bis[di[(4-(2-hydroxy-ethoxy)-phenyl)]sulfoxonium)diphenyl sulfide, 4,4′-bis(diphenyl sulfoxonium)biphenylene, diphenyl(o-fluorophenyl)sulfoxonium, diphenyl(m-chlorophenyl)sulfoxonium, diphenyl(p-bromophenyl)sulfoxonium, diphenyl(p-cyanophenyl)sulfoxonium, diphenyl(m-nitrophenyl)sulfoxonium, diphenyl(2,4,6-tribromophenyl)sulfoxonium, diphenyl(pentafluorophenyl)sulfoxonium, diphenyl(p-(trifluoromethyl)phenyl)sulfoxonium, diphenyl(p-hydroxyphenyl)sulfoxonium, diphenyl(p-mercaptophenyl)sulfoxonium, diphenyl(p-methylsulfinylphenyl)sulfoxonium, diphenyl(p-methylsulfonylphenyl)sulfoxonium, diphenyl(o-acetylphenyl)sulfoxonium, diphenyl(o-benzoylphenyl)sulfoxonium, diphenyl(p-methylphenyl)sulfoxonium, diphenyl(p-isopropylphenyl)sulfoxonium, diphenyl(p-octadecylphenyl)sulfoxonium, diphenyl(p-cyclohexylphenyl)sulfoxonium, diphenyl(p-methoxyphenyl)sulfoxonium, diphenyl(o-methoxycarbonylphenyl)sulfoxonium, diphenyl(p-phenylsulfanylphenyl)sulfoxonium, (7-methoxy-2-oxo-2H-chromen-4-yl)diphenyl sulfoxonium, (4-methoxynaphthalene-1-yl)diphenyl sulfoxonium, diphenyl(p-isopropoxycarbonylphenyl)sulfoxonium, diphenyl(2-naphthyl)sulfoxonium, diphenyl(9-anthryl)sulfoxonium, ethyl diphenyl sulfoxonium, methyl ethyl(o-tolyl)sulfoxonium, methyl di(p-tolyl)sulfoxonium, tri(p-tolyl)sulfoxonium, diisopropyl(4-phenylsulfanylphenyl)sulfoxonium, diphenyl(2-thienyl)sulfoxonium, diphenyl(2-furyl)sulfoxonium, and diphenyl(9-ethyl-9H-carbazol-3-yl)sulfoxonium.

Examples of the onium cation (phosphonium cation) corresponding to formula (6) include, but are not limited to, trimethyl phenyl phosphonium, triethyl phenyl phosphonium, tetraphenyl phosphonium, triphenyl(p-fluorophenyl)phosphonium, triphenyl(o-chlorophenyl)phosphonium, triphenyl(m-bromophenyl)phosphonium, triphenyl(p-cyanophenyl)phosphonium, triphenyl(m-nitrophenyl)phosphonium, triphenyl(p-phenylsulfanylphenyl)phosphonium, (7-methoxy-2-oxo-2H-chromen-4-yl)triphenyl phosphonium, triphenyl(o-hydroxyphenyl)phosphonium, triphenyl(o-acetylphenyl)phosphonium, triphenyl(m-benzoylphenyl)phosphonium, triphenyl(p-methylphenyl)phosphonium, triphenyl(p-isopropoxyphenyl)phosphonium, triphenyl(o-methoxycarbonylphenyl)phosphonium, triphenyl(1-naphthyl)phosphonium, triphenyl(9-anthryl)phosphonium, triphenyl(2-thienyl)phosphonium, triphenyl(2-furyl)phosphonium, and triphenyl(9-ethyl-9H-carbazol-3-yl)phosphonium.

Examples of the onium cation (pyridinium cation) corresponding to formula (7) include, but are not limited to, N-phenylpyridinium, N-(o-chlorophenyl)pyridinium, N-(m-chlorophenyl)pyridinium, N-(p-cyanophenyl)pyridinium, N-(o-nitrophenyl)pyridinium, N-(p-acetylphenyl)pyridinium, N-(p-isopropylphenyl)pyridinium, N-(p-octadecyloxyphenyl)pyridinium, N-(p-methoxycarbonylphenyl)pyridinium, N-(9-anthryl)pyridinium, 2-chloro-1-phenylpyridinium, 2-cyano-1-phenylpyridinium, 2-methyl-1-phenylpyridinium, 2-vinyl-1-phenylpyridinium, 2-phenyl-1-phenylpyridinium, 1,2-diphenylpyridinium, 2-methoxy-1-phenylpyridinium, 2-phenoxy-1-phenylpyridinium, 2-acetyl-1-(p-tolyl)pyridinium, 2-methoxycarbonyl-1-(p-tolyl)pyridinium, 3-fluoro-1-naphthylpyridinium, 4-methyl-1-(2-furyl)pyridinium, N-methylpyridinium, and N-ethylpyridinium.

Examples of the onium cation (quinolinium cation) corresponding to formula (8) include, but are not limited to, N-methylquinolinium, N-ethylquinolinium, N-phenylquinolinium, N-naphthylquinolinium, N-(o-chlorophenyl)quinolinium, N-(m-chlorophenyl)quinolinium, N-(p-cyanophenyl)quinolinium, N-(o-nitrophenyl)quinolinium, N-(p-acetylphenyl)quinolinium, N-(p-isopropylphenyl)quinolinium, N-(p-octadecyloxyphenyl)quinolinium, N-(p-methoxycarbonylphenyl)quinolinium, N-(9-anthryl)quinolinium, 2-chloro-1-phenylquinolinium, 2-cyano-1-phenylquinolinium, 2-methyl-1-phenylquinolinium, 2-vinyl-1-phenylquinolinium, 2-phenyl-1-phenylquinolinium, 1,2-diphenylquinolinium, 2-methoxy-1-phenylquinolinium, 2-phenoxy-1-phenylquinolinium, 2-acetyl-1-phenylquinolinium, 2-methoxycarbonyl-1-phenylquinolinium, 3-fluoro-1-phenylquinolinium, 4-methyl-1-phenylquinolinium, 2-methoxy-1-(p-tolyl)quinolinium, 2-phenoxy-1-(2-furyl)quinolinium, 2-acetyl-1-(2-thienyl)quinolinium, 2-methoxycarbonyl-1-methylquinolinium, 3-fluoro-1-ethylquinolinium, and 4-methyl-1-isopropylquinolinium.

Examples of the onium cation (isoquinolinium cation) corresponding to formula (9) include, but are not limited to, N-phenylisoquinolinium, N-methylisoquinolinium, N-ethylisoquinolinium, N-(o-chlorophenyl)isoquinolinium, N-(m-chlorophenyl)isoquinolinium, N-(p-cyanophenyl)isoquinolinium, N-(o-nitrophenyl)isoquinolinium, N-(p-acetylphenyl)isoquinolinium, N-(p-isopropylphenyl)isoquinolinium, N-(p-octadecyloxyphenyl)isoquinolinium, N-(p-methoxycarbonylphenyl)isoquinolinium, N-(9-anthryl)isoquinolinium, 1,2-diphenylisoquinolinium, N-(2-furyl)isoquinolinium, N-(2-thienyl)isoquinolinium, and N-naphthylisoquinolinium.

Examples of the onium cation (benzoxazolium cation) corresponding to formula (10) include, but are not limited to, N-methylbenzoxazolium, N-ethylbenzoxazolium, N-naphthylbenzoxazolium, N-phenylbenzoxazolium, N-(p-fluorophenyl)benzoxazolium, N-(p-chlorophenyl)benzoxazolium, N-(p-cyanophenyl)benzoxazolium, N-(o-methoxycarbonylphenyl)benzoxazolium, N-(2-furyl)benzoxazolium, N-(o-fluorophenyl)benzoxazolium, N-(p-cyanophenyl)benzoxazolium, N-(m-nitrophenyl)benzoxazolium, N-(p-isopropoxycarbonylphenyl)benzoxazolium, N-(2-thienyl)benzoxazolium, N-(m-carboxyphenyl)benzoxazolium, 2-mercapto-3-phenylbenzoxazolium, 2-methyl-3-phenylbenzoxazolium, 2-methylthio-3-(4-phenylsulfanylphenyl)benzoxazolium, 6-hydroxy-3-(p-tolyl)benzoxazolium, 7-mercapto-3-phenylbenzoxazolium, and 4,5-difluoro-3-ethylbenzoxazolium.

Examples of the onium cation (benzothiazolium cation) corresponding to formula (10) include, but are not limited to, N-methylbenzothiazolium, N-ethylbenzothiazolium, N-phenylbenzothiazolium, N-(1-naphthyl)benzothiazolium, N-(p-fluorophenyl)benzothiazolium, N-(p-chlorophenyl)benzothiazolium, N-(p-cyanophenyl)benzothiazolium, N-(o-methoxycarbonylphenyl)benzothiazolium, N-(p-tolyl)benzothiazolium, N-(o-fluorophenyl)benzothiazolium, N-(m-nitrophenyl)benzothiazolium, N-(p-isopropoxycarbonylphenyl)benzothiazolium, N-(2-furyl)benzothiazolium, N-(4-methylthiophenyl)benzothiazolium, N-(4-phenylsulfanylphenyl)benzothiazolium, N-(2-naphthyl)benzothiazolium, N-(m-carboxyphenyl)benzothiazolium, 2-mercapto-3-phenylbenzothiazolium, 2-methyl-3-phenylbenzothiazolium, 2-methylthio-3-phenylbenzothiazolium, 6-hydroxy-3-phenylbenzothiazolium, 7-mercapto-3-phenylbenzothiazolium, and 4,5-difluoro-3-phenylbenzothiazolium.

Examples of the onium cation (furyl- or thienyl-iodonium cation) corresponding to formula (11) include, but are not limited to, difuryliodonium, dithienyliodonium, bis(4,5-dimethyl-2-furyl)iodonium, bis(5-chloro-2-thienyl)iodonium, bis(5-cyano-2-furyl)iodonium, bis(5-nitro-2-thienyl)iodonium, bis(5-acetyl-2-furyl)iodonium, bis(5-carboxy-2-thienyl)iodonium, bis(5-methoxycarbonyl-2-furyl)iodonium, bis(5-phenyl-2-furyl)iodonium, bis(5-(p-methoxyphenyl)-2-thienyl)iodonium, bis(5-vinyl-2-furyl)iodonium, bis(5-ethynyl-2-thienyl)iodonium, bis(5-cyclohexyl-2-furyl)iodonium, bis(5-hydroxy-2-thienyl)iodonium, bis(5-phenoxy-2-furyl)iodonium, bis(5-mercapto-2-thienyl)iodonium, bis(5-butylthio-2-thienyl)iodonium, and bis(5-phenylthio-2-thienyl)iodonium.

Examples of the onium cation (diaryliodonium cation) corresponding to formula (12) include, but are not limited to, diphenyliodonium, bis(p-tolyl)iodonium, bis(p-octylphenyl)iodonium, bis(p-octadecylphenyl)iodonium, bis(p-octyloxyphenyl)iodonium, bis(p-octadecyloxyphenyl)iodonium, phenyl(p-octadecyloxyphenyl)iodonium, 4-isopropyl-4′-methyldiphenyliodonium, (4-isobutylphenyl)-p-tolyliodonium, bis(1-naphthyl)iodonium, bis(4-phenylsulfanylphenyl)iodonium, phenyl(6-benzoyl-9-ethyl-9H-carbazol-3-yl)iodonium, and (7-methoxy-2-oxo-2H-chromen-3-yl)-4′-isopropylphenyliodonium.

Next, the counter anion X⁻ in formula (3) will be described.

Although not restricted in principle, the counter anion X⁻ in formula (3) is preferably a non-nucleophilic anion. When the counter anion X⁻ is a non-nucleophilic anion, nucleophilic reaction is less likely to occur with the coexisting cation in the molecule or with various materials used in combination with the anion, so that the photo-acid generator of formula (4) itself and the composition containing it can have improved stability over time. As used herein, the term “non-nucleophilic anion” refers to an anion less capable of undergoing nucleophilic reaction. Examples of such an anion include PF₆⁻, SbF₆⁻, SbCl₆⁻, BiCl₅⁻, SnCl₆⁻, ClO₄⁻, dithiocarbamate anion, and SCN⁻.

In particular, among the anions listed above, the counter anion X⁻ in formula (3) is preferably PF₆⁻, SbF₆⁻, or AsF₆⁻, more preferably PF₆⁻ or SbF₆⁻.

In the present invention, therefore, preferred examples of the onium salt that forms the photo-acid generator (H) include onium salts composed of any of examples of the onium cation structures of formulae (4) to (12) shown above and any anion selected from PF₆⁻, SbF₆⁻, AsF₆⁻, SbCl₆⁻, BiCl₅⁻, SnCl₆⁻, ClO₄⁻, dithiocarbamate anion, and SCN⁻.

More specifically, in the present invention, preferred examples of the photo-acid generator (H) include CYRACURE UVI-6992 and CYRACURE UVI-6974 (all manufactured by The Dow Chemical Company), ADEKA OPTOMER SP150, ADEKA OPTOMER SP152, ADEKA OPTOMER SP170, and ADEKA OPTOMER SP172 (all manufactured by ADEKA CORPORATION), IRGACURE 250 (manufactured by Ciba Specialty Chemicals Inc.), CI-5102 and CI-2855 (all manufactured by Nippon Soda Co., Ltd.), SAN-AID SI-60L, SAN-AID SI-80L, SAN-AID SI-100L, SAN-AID SI-110L, and SAN-AID SI-180L (all manufactured by SANSHIN CHEMICAL INDUSTRY CO., LTD.), CPI-100P and CPI-100A (all manufactured by SAN-APRO LTD.), and WPI-069, WPI-113, WPI-116, WPI-041, WPI-044, WPI-054, WPI-055, WPAG-281, WPAG-567, and WPAG-596 (all manufactured by Wako Pure Chemical Industries, Ltd.).

The content of the photo-acid generator (H) is preferably from 0.01 to 10% by weight, more preferably from 0.05 to 5% by weight, even more preferably from 0.1 to 3% by weight, based on the total amount of the active energy ray-curable resin composition.

(Epoxy Group-Containing Compound and Polymer) (H)

A compound having one or more epoxy groups per molecule or a polymer (epoxy resin) having two or more epoxy groups per molecule may be used. In this case, a compound having two or more functional groups per molecule reactive with an epoxy group may be used in combination with the epoxy group-containing compound or polymer. The functional group reactive with an epoxy group is typically carboxyl, phenolic hydroxyl, mercapto, or primary or secondary aromatic amino. In particular, the compound preferably has two or more functional groups of any of these types per molecule in view of three-dimensionally curing properties.

Examples of polymers having one or more epoxy groups per molecule include epoxy resins such as bisphenol A epoxy resins derived from bisphenol A and epichlorohydrin, bisphenol F epoxy resins derived from bisphenol F and epichlorohydrin, bisphenol S epoxy resins, phenol novolac epoxy resins, cresol novolac epoxy resins, bisphenol A novolac epoxy resins, bisphenol F novolac epoxy resins, alicyclic epoxy resins, diphenyl ether epoxy resins, hydroquinone epoxy resins, naphthalene epoxy resins, biphenyl epoxy resins, fluorene epoxy resins, polyfunctional epoxy resins such as trifunctional epoxy resins and tetrafunctional epoxy resins, glycidyl ester epoxy resins, glycidyl amine epoxy resins, hydantoin epoxy resins, isocyanurate epoxy resins, and aliphatic chain epoxy resins. These epoxy resins may be halogenated or hydrogenated. Examples of commercially available epoxy resin products include, but are not limited to, JER Coat 828, 1001, 801N, 806, 807, 152, 604, 630, 871, YX8000, YX8034, and YX4000 manufactured by Japan Epoxy Resins Co., Ltd., EPICLON 830, EPICLON EXA-835LV, EPICLON HP-4032D, and EPICLON HP-820 manufactured by DIC Corporation, EP4100 series, EP4000 series, and EPU series manufactured by ADEKA CORPORATION, CELLOXIDE series (e.g., 2021, 2021P, 2083, 2085, and 3000), EPOLEAD series, and EHPE series manufactured by DAICEL CORPORATION, YD series, YDF series, YDCN series, YDB series, and phenoxy resins (polyhydroxypolyethers synthesized from bisphenols and epichlorohydrin and terminated at both ends with epoxy groups, e.g, YP series) manufactured by NIPPON STEEL & SUMIKIN CHEMICAL CO., LTD., DENACOL series manufactured by Nagase ChemteX Corporation, and Epolite series manufactured by Kyoeisha Chemical Co., Ltd. These epoxy resins may be used in combination of two or more. It should be noted that the epoxy group-containing compound and polymer (H) are not taken into account in the calculation of the glass transition temperature Tg of the adhesive layer.

(Alkoxyl Group-Containing Compound and Polymer) (I)

The compound having an alkoxyl group in the molecule may be any known compound having at least one alkoxyl group per molecule. Such a compound is typically a melamine compound, an amino resin, a silane coupling agent, or the like. It should be noted that the alkoxyl group-containing compound and polymer (H) are not taken into account in the calculation of the glass transition temperature Tg of the adhesive layer.

Examples of an amino group-containing silane coupling agent (J) include amino group-containing silanes such as γ-aminopropyltrimethoxysilane, γ-aminopropyltriethoxysilane, γ-aminopropyltriisopropoxysilane, γ-aminopropylmethyldimethoxysilane, γ-aminopropylmethyldiethoxysilane, γ-(2-aminoethyl)aminopropyltrimethoxysilane, γ-(2-aminoethyl)aminopropylmethyldimethoxysilane, γ-(2-aminoethyl)aminopropyltriethoxysilane, γ-(2-aminoethyl)aminopropylmethyldiethoxysilane, γ-(2-aminoethyl)aminopropyltriisopropoxysilane, γ-(2-(2-aminoethyl)aminoethyl)aminopropyltrimethoxysilane, γ-(6-aminohexyl)aminopropyltrimethoxysilane, 3-(N-ethylamino)-2-methylpropyltrimethoxysilane, γ-ureidopropyltrimethoxysilane, γ-ureidopropyltriethoxysilane, N-phenyl-γ-aminopropyltrimethoxysilane, N-benzyl-γ-aminopropyltrimethoxysilane, N-vinylbenzyl-γ-aminopropyltriethoxysilane, N-cyclohexylaminomethyltriethoxysilane, N-cyclohexylaminomethyldiethoxymethylsilane, N-phenylaminomethyltrimethoxysilane, (2-aminoethyl)aminomethyltrimethoxysilane, and N,N′-bis[3-(trimethoxysilyl)propyl]ethylenediamine; and ketimine silanes such as N-(1,3-dimethylbutylidene)-3-(triethoxysilyl)-1-propaneamine.

These amino group-containing silane coupling agents (J) may be used singly or in combination of two or more. Among them, γ-aminopropyltrimethoxysilane, γ-(2-aminoethyl)aminopropyltrimethoxysilane, γ-(2-aminoethyl)aminopropylmethyldimethoxysilane, γ-(2-aminoethyl)aminopropyltriethoxysilane, γ-(2-aminoethyl)aminopropylmethyldiethoxysilane, and N-(1,3-dimethylbutylidene)-3-(triethoxysilyl)-1-propaneamine are preferred in order to ensure good adhesion.

The content of the amino group-containing silane coupling agent (J) is preferably in the range of 0.01 to 20% by weight, more preferably 0.05 to 15% by weight, even more preferably 0.1 to 10% by weight, based on 100% by weight of the total amount of the composition. If the content is more than 20% by weight, the adhesive may have poor storage stability, and if the content is less than 0.1% by weight, the water-resistant adhesion effect may fail to be sufficiently produced. It should be noted that the amino group-containing silane coupling agent (J) is not taken into account in the calculation of the glass transition temperature Tg of the adhesive layer.

When the active energy ray-curable adhesive composition is to be used as an electron beam-curable type, it is not particularly necessary to add a photopolymerization initiator to the composition. However, when the adhesive composition is to be used as a visible light- or ultraviolet-curable type, a photopolymerization initiator is preferably used in the adhesive composition, and in particular, a photopolymerization initiator having high sensitivity to light of 380 nm or longer is preferably used in the adhesive composition. The photopolymerization initiator having high sensitivity to light of 380 nm or longer will be described below.

In the active energy ray-curable adhesive composition, a compound represented by formula (1):

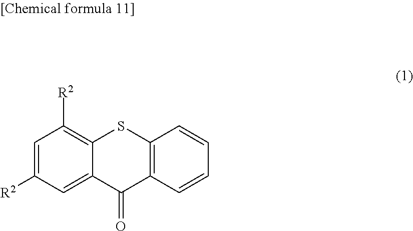

wherein R¹ and R² each represent —H, —CH₂CH₃, -i-Pr, or Cl, and R¹ and R² may be the same or different, is preferably used alone as a photopolymerization initiator or preferably used as a photopolymerization initiator in combination with another photopolymerization initiator having high sensitivity to light of 380 nm or longer described below. The resulting adhesion is higher when the compound of formula (1) is used than when a photopolymerization initiator having high sensitivity to light of 380 nm or longer is used alone. In particular, the compound of formula (1) is preferably diethyl thioxanthone in which R¹ and R² are each —CH₂CH₃. Based on 100% by weight of the total amount of the composition, the content of the compound of formula (1) in the composition is preferably from 0.1 to 5.0% by weight, more preferably from 0.5 to 4.0% by weight, even more preferably from 0.9 to 3.0% by weight.

If necessary, a polymerization initiation aid is preferably added to the composition. In particular, the polymerization initiation aid is preferably triethylamine, diethylamine, N-methyldiethanolamine, ethanolamine, 4-dimethylaminobenzoic acid, methyl 4-dimethylaminobenzoate, ethyl 4-dimethylaminobenzoate, or isoamyl 4-dimethylaminobenzoate. Ethyl 4-dimethylaminobenzoate is particularly preferred. When the polymerization initiation aid is used, the content of the aid is generally 0 to 5% by weight, preferably 0 to 4% by weight, most preferably 0 to 3% by weight, based on 100% by weight of the total amount of the composition.

If necessary, a known photopolymerization initiator may be used in combination. If the film substrate such as the first or second film substrate has the ability to absorb UV, it will not transmit light of 380 nm or shorter. Therefore, such a photopolymerization initiator should preferably have high sensitivity to light of 380 nm or longer. Examples of such an initiator include 2-methyl-1-(4-methylthiophenyl)-2-morpholinopropan-1-one, 2-benzyl-2-dimethylamino-1-(4-morpholinophenyl)-butanone-1,2-(dimethylamino)-2-[(4-methylphenyl)methyl]-1-(4-(4-morpholinyl)phenyl]-1-butanone, 2,4,6-trimethylbenzoyl-diphenyl-phosphine oxide, bis(2,4,6-trimethylbenzoyl)-phenylphosphine oxide, and bis(n5-2,4-cyclopentadien-1-yl)-bis(2,6-difluoro-3-(1H-pyrrol-1-yl)-phenyl)titanium.

In particular, a compound represented by formula (2):

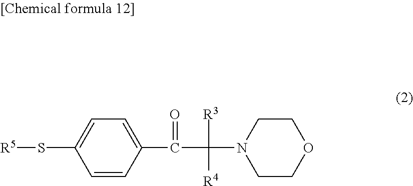

wherein R³, R⁴, and R⁵ each represent —H, —CH₃, —CH₂CH₃, -i-Pr, or Cl, and R³, R⁴, and R⁵ may be the same or different, is preferably used in addition to the photopolymerization initiator of formula (1). Commercially available 2-methyl-1-(4-methylthiophenyl)-2-morpholinopropan-1-one (IRGACURE 907 (trade name) manufactured by BASF) is advantageously used as the compound of formula (2). Besides this, 2-benzyl-2-dimethylamino-1-(4-morpholinophenyl)-butanone-1 (IRGACURE 369 (trade name) manufactured by BASF) and 2-(dimethylamino)-2-[(4-methylphenyl)methyl]-1-[4-(4-morpholinyl)phenyl]-1-butanone (IRGACURE 379 (trade name) manufactured by BASF) are preferred because of their high sensitivity.

The active energy ray-curable adhesive composition may also contain any of various additives as other optional components as long as the objects and effects of the present invention are not impaired. Examples of such additives include polymers or oligomers such as epoxy resin, polyamide, polyamide imide, polyurethane, polybutadiene, polychloroprene, polyether, polyester, styrene-butadiene block copolymers, petroleum resin, xylene resin, ketone resin, cellulose resin, fluorooligomers, silicone oligomers, and polysulfide oligomers, polymerization inhibitors such as phenothiazine and 2,6-di-tert-butyl-4-methylphenol, polymerization initiation aids, leveling agents, wettability modifiers, surfactants, plasticizers, ultraviolet absorbers, silane coupling agents, inorganic fillers, pigments, and dyes.

Among these additives, silane coupling agents can impart higher adhesion by acting on the surface of the film substrate such as the first or second film substrate. When a silane coupling agent is used, the content of the silane coupling agent is generally 0 to 10% by weight, preferably 0 to 5% by weight, most preferably 0 to 3% by weight, based on 100% by weight of the total amount of the composition.

The silane coupling agent to be used is preferably an active energy ray-curable compound. However, even when it is not active energy ray-curable, it can also impart a similar level of water resistance.

Examples of silane coupling agents as active energy ray-curable compounds include vinyltrichlorosilane, vinyltrimethoxysilane, vinyltriethoxysilane, 2-(3,4-epoxycyclohexyl)ethyltrimethoxysilane, 3-glycidoxypropyltrimethoxysilane, 3-glycidoxypropylmethyldiethoxysilane, 3-glycidoxypropyltriethoxysilane, p-styryltrimethoxysilane, 3-methacryloxypropylmethyldimethoxysilane, 3-methacryloxypropyltrimethoxysilane, 3-methacryloxypropylmethyldiethoxysilane, 3-methacryloxypropyltriethoxysilane, and 3-acryloxypropyltrimethoxysilane.

Examples of non-active-energy-ray-curable silane coupling agents include N-2-(aminoethyl)-3-aminopropylmethyldimethoxysilane, N-2-(aminoethyl)-3-aminopropyltrimethoxysilane, N-2-(aminoethyl)-3-aminopropyltriethoxysilane, 3-aminopropyltrimethoxysilane, 3-aminopropyltriethoxysilane, 3-triethoxysilyl-N-(1,3-dimethylbutylidene)propylamine, N-phenyl-3-aminopropyltrimethoxysilane, N-(vinylbenzyl)-2-aminoethyl-3-aminopropyltrimethoxysilane hydrochloride, 3-ureidopropyltriethoxysilane, 3-chloropropyltrimethoxysilane, 3-mercaptopropylmethyldimethoxysilane, 3-mercaptopropyltrimethoxysilane, bis(triethoxysilylpropyl)tetrasulfide, 3-isocyanatopropyltriethoxysilane, and imidazolesilane.

Preferred are 3-methacryloxypropyltrimethoxysilane and 3-acryloxypropyltrimethoxysilane.

When used according to the present invention, the active energy ray-curable adhesive composition is cured to form an adhesive layer by being irradiated with active energy rays.

The active energy rays to be used may include electron beams or visible rays with a wavelength in the range of 380 nm to 450 nm. Although the long wavelength limit of the visible rays is around 780 nm, visible rays with wavelengths of more than 450 nm would not take part in the absorption by polymerization initiators and may cause a transparent protective film and a polarizer to generate heat. In the present invention, therefore, a band pass filter is preferably used to block visible rays with wavelengths longer than 450 nm.

Electron beams may be applied under any appropriate conditions where the active energy ray-curable adhesive composition can be cured. For example, electron beams are preferably applied at an acceleration voltage of 5 kV to 300 kV, more preferably 10 kV to 250 kV. If the acceleration voltage is lower than 5 kV, electron beams may fail to reach the adhesive, so that insufficient curing may occur. If the acceleration voltage is higher than 300 kV, electron beams can have too high intensity penetrating through the material and thus may damage a transparent protective film or a polarizer. The exposure dose is preferably from 5 to 100 kGy, more preferably from 10 to 75 kGy. At an exposure dose of less than 5 kGy, the adhesive may be insufficiently cured. An exposure dose of more than 100 kGy may damage a transparent protective film or a polarizer and cause yellow discoloration or a reduction in mechanical strength, which may make it impossible to obtain the desired optical properties.

Electron beam irradiation is generally performed in an inert gas. If necessary, however, electron beam irradiation may be performed in the air or under conditions where a small amount of oxygen is introduced. When oxygen is appropriately introduced, oxygen-induced inhibition can be intentionally produced on the surface of a transparent protective film, to which electron beams are first applied, so that the transparent protective film can be prevented from being damaged and electron beams can be efficiently applied only to the adhesive, although it depends on the material of the transparent protective film.

The method according to the present invention for manufacturing a polarizing film can prevent curling of the polarizing film while increasing the adhesion performance of the adhesive layer between the polarizer and the transparent protective film. In order to achieve this effect, the active energy rays used preferably include visible rays with a wavelength in the range of 380 nm to 450 nm, specifically, visible rays whose dose is the highest at a wavelength in the range of 380 nm to 450 nm. When the transparent protective film used has the ability to absorb ultraviolet rays (the ultraviolet non-transmitting transparent protective film), it can absorb light with wavelengths shorter than about 380 nm. This means that light with wavelengths shorter than 380 nm cannot reach the active energy ray-curable adhesive composition and thus cannot contribute to the polymerization reaction of the composition. When absorbed by the transparent protective film, the light with wavelengths shorter than 380 nm is also converted into heat, so that the transparent protective film itself can generate heat, which can cause a defect such as curling or wrinkling of the polarizing film. In the present invention, therefore, the active energy ray generator used preferably does not emit light with wavelengths shorter than 380 nm. More specifically, the ratio of the total illuminance in the wavelength range of 380 to 440 nm to the total illuminance in the wavelength range of 250 to 370 nm is preferably from 100:0 to 100:50, more preferably from 100:0 to 100:40. The source of energy rays satisfying such a relation for the total illuminance is preferably a gallium-containing metal halide lamp or an LED light source emitting light with a wavelength in the range of 380 to 440 nm. Alternatively, a low-pressure mercury lamp, a middle-pressure mercury lamp, a high-pressure mercury lamp, an ultrahigh-pressure mercury lamp, an incandescent lamp, a xenon lamp, a halogen lamp, a carbon arc lamp, a metal halide lamp, a fluorescent lamp, a tungsten lamp, a gallium lamp, an excimer laser, or sunlight may be used as the light source in combination with a band pass filter for blocking light with wavelengths shorter than 380 nm. For the purpose of preventing the polarizing film from curling while increasing the adhesion performance of the adhesive layer between the polarizer and the transparent protective film, it is preferable to use active energy rays obtained through a band pass filter capable of blocking light with wavelengths shorter than 400 nm or to use active energy rays with a wavelength of 405 nm obtained with an LED light source.

When the active energy ray-curable adhesive composition is visible ray-curable, the active energy ray-curable adhesive composition is preferably heated before irradiated with visible rays (heating before irradiation). In this case, the composition is preferably heated to 40° C. or higher, more preferably 50° C. or higher. The active energy ray-curable adhesive composition is also preferably heated after irradiated with visible rays (heating after irradiation). In this case, the composition is preferably heated to 40° C. or higher, more preferably 50° C. or higher.

The active energy ray-curable adhesive composition is particularly suitable for use in forming the transparent cured adhesive layer for bonding the film substrate such as the first or second film substrate with a 365 nm wavelength light transmittance of less than 5%. When the active energy ray-curable adhesive composition contains the photopolymerization initiator of formula (1) shown above, the transparent cured adhesive layer can be formed by curing the composition in such a way that the composition is irradiated with visible or ultraviolet rays through the film substrate such as the first or second film substrate having the ability to absorb UV. It will be understood, however, that the transparent cured adhesive layer can also be formed by curing even when the film substrate such as the first or second film substrate has no ability to absorb UV. As used herein, the term the film substrate such as the first or second film substrate having the ability to absorb UV″ means that the film substrate such as the first or second film substrate has a transmittance of less than 10% for light at 380 nm.

Methods for imparting the ability to absorb UV to the film substrate such as the first or second film substrate include a method of adding an ultraviolet absorber into the film substrate such as the first or second film substrate and a method of forming an ultraviolet absorber-containing surface treatment layer on the surface of the film substrate such as the first or second film substrate.

Examples of the ultraviolet absorber include conventionally known oxybenzophenone compounds, benzotriazole compounds, salicylate ester compounds, benzophenone compounds, cyanoacrylate compounds, nickel complex salt compounds, and triazine compounds.

The thickness of the transparent cured adhesive layer is preferably controlled to 0.01 μm to 10 μm. The thickness of the transparent cured adhesive layer is preferably from 0.01 to 8 μm, more preferably from 0.01 to 5 μm, even more preferably from 0.01 to 2 μm, most preferably from 0.01 to 1 μm. If the thickness of the transparent cured adhesive layer is less than 0.01 μm, the adhesive itself may fail to have a cohesive strength, and a necessary bonding strength may fail to be obtained. On the other hand, setting the thickness of the transparent cured adhesive layer to 10 μm or less is preferable in that the time required to cure the adhesive composition can be easily controlled.

Although not shown in FIGS. 1 to 4, the transparent conductive laminated film A may include an undercoat layer on one surface of the first, second, or third film substrate 11, 12, or 13, and the transparent conductive layer 21 or 22 may be formed on the first, second, or third film substrate 11, 12, or 13 with the undercoat layer interposed therebetween. The undercoat layer may be a laminated structure of two or more sub layers.

Although not shown in FIGS. 1 to 4, the transparent conductive laminated film A may include an oligomer layer on one surface of the first, second, or third film substrate 11, 12, or 13, and the transparent cured adhesive layer 3 may be provided on the first, second, or third film substrate 11, 12, or 13 with the oligomer layer interposed therebetween.

The transparent conductive layer generally has a refractive index of about 1.95 to about 2.05. When the undercoat layer is formed, there is preferably a difference of 0.1 or more between the refractive indices of the undercoat layer and the transparent conductive layer.

The undercoat layer may be made of an inorganic material, an organic material, or a mixture of inorganic and organic materials. Examples of the inorganic material include NaF (1.3), Na₃AlF₆ (1.35), LiF (1.36), MgF₂ (1.38), CaF₂ (1.4), BaF₂ (1.3), SiO₂ (1.46), LaF₃ (1.55), CeF₃ (1.63), Al₂O₃ (1.63), and other inorganic materials, wherein the value in each pair of parentheses is the refractive index of each material. Among them, SiO₂, MgF₂, and Al₂O₃ are preferably used, and SiO₂ is particularly preferred. Besides the above, a complex oxide including indium oxide, about 10 to about 40 parts by weight of cerium oxide, and 0 to about 20 parts by weight of tin oxide may also be used.

Using the inorganic material, the undercoat layer can be formed by a dry process such as vacuum deposition, sputtering, or ion plating, or a wet process (a coating method). As mentioned above, SiO₂ is preferably used as an inorganic material to form the undercoat layer. In a wet process, a silica sol or the like may be applied so that a SiO₂ coating can be formed.

Examples of the organic material include acrylic resin, urethane resin, melamine resin, alkyd resin, siloxane-based polymers, and organosilane condensates. At least one of these organic materials may be used. In particular, a thermosetting resin including a mixture of a melamine resin, an alkyd resin, and an organosilane condensate is preferably used.

The undercoat layer may be provided between the first or second film substrate and the transparent conductive layer. The undercoat layer has no function as a conductive layer. In other words, the undercoat layer is provided as a dielectric layer for insulation between parts of a patterned transparent conductive layer. Therefore, the undercoat layer generally has a surface resistance of 1×10⁶ Ω/square or more, preferably 1×10⁷ Ω/square or more, more preferably 1×10⁸ Ω/square or more. There is no specific upper limit to the surface resistance of the undercoat layer. In general, a measuring limit of about 1×10¹³ Ω/square may be set as an upper limit of the surface resistance of the undercoat layer, but it may have a surface resistance of more than 1×10¹³ Ω/square.

The undercoat layer preferably has such a refractive index that there is a difference of 0.1 or more between the refractive indices of the transparent conductive layer and the undercoat layer. The difference between the refractive indices of the transparent conductive layer and the undercoat layer is preferably from 0.1 to 0.9, more preferably from 0.1 to 0.6. The refractive index of the undercoat layer is generally from 1.3 to 2.5, preferably from 1.38 to 2.3, more preferably from 1.4 to 2.3.

The thickness of the undercoat layer is generally, but not limited to, about 1 to about 300 nm, preferably 5 to 300 nm, in view of optical design and the effect of preventing the occurrence of oligomers from the first or second film substrate. When two or more undercoat layers are provided, each layer may have a thickness of about 5 to about 250 nm, preferably 10 to 250 nm.

The transparent conductive laminated film A of FIG. 1 or 3 may also have a functional layer provided on the surface of the laminated film A′ opposite to the first transparent conductive layer 21 (on one surface of the second film substrate 12 in FIG. 1 or one surface of the third film substrate 13 in FIG. 3, wherein the one surface is opposite to the transparent cured adhesive layer 3). An antiglare layer, an antireflection layer, or a hard coat layer may be provided as the functional layer.

The material used to form the antiglare layer may be of any type such as ionizing radiation-curable resin, thermosetting resin, or thermoplastic resin. The antiglare layer preferably has a thickness of 0.1 to 30 μm.

The antireflection layer may be made of titanium oxide, zirconium oxide, silicon oxide, magnesium fluoride, or the like. A stack of titanium oxide and silicon oxide layers is preferably used to produce a higher level of antireflection function.

The transparent conductive laminated film of the present invention may be produced by any method capable of forming the structure described above. Hereinafter, an example of such a production method will be described.

For example, first, a transparent conductive film is prepared having a first transparent conductive layer on one surface of a first film substrate (step (a)). The preparing step (a) generally includes forming the first transparent conductive layer (and optionally an undercoat layer) on one surface of the first film substrate. When the transparent conductive laminated film shown in FIG. 2 or 4 is produced, specifically, when a transparent conductive layer is provided on a second or third film substrate, another transparent conductive film may be prepared having a second transparent conductive layer on one surface of the second or third film substrate.

Subsequently, the surface of the first film substrate of the transparent conductive film (prepared in the step (a)), opposite to its surface on which the first transparent conductive layer is provided, is bonded to the second film substrate with a transparent uncured adhesive layer (step (b)). The transparent uncured adhesive layer can be formed by applying the curable adhesive to at least one of the first and second film substrates. When a laminated film having a third film substrate is formed as shown in FIG. 3 or 4, a laminate of the second and third film substrates may be used, in which the substrates are bonded with a transparent uncured adhesive layer in advance.

The method for applying the curable adhesive is appropriately selected depending on the viscosity and the desired thickness of the adhesive. Examples of the means for application include a reverse coater, a gravure coater (direct, reverse, or offset), a bar reverse coater, a roll coater, a die coater, a bar coater, and a rod coater. Other means such as dipping may also be used as appropriate for the application.

The first and second film substrates are bonded with the transparent uncured adhesive layer interposed therebetween. The first and second film substrates can be bonded using a roll laminator or the like.

Subsequently, the transparent uncured adhesive layer, which is used to bond the first and second film substrates in the step (b), is cured (step (c)), so that a transparent conductive laminated film is obtained. The curing method is appropriately determined depending on the type of the adhesive. When the active energy ray-curable adhesive is used, the cured adhesive layer is formed by irradiation with active energy rays (such as electron beams or ultraviolet rays). The active energy rays (such as electron beams or ultraviolet rays) may be applied from any appropriate direction. Preferably, the active energy rays are applied from the second film substrate side, so that a higher level of active energy ray transmittance can be achieved.

The step (b) may include forming an oligomer blocking layer or an adhesion facilitating layer on the surface of the first or second film substrate before the curable adhesive is applied to the first or second film substrate. Any appropriate material capable of forming a transparent film may be used to form the oligomer blocking layer or the adhesion facilitating layer. Such a material may be an inorganic material, an organic material, or a composite material of them. These layers preferably have a thickness of 0.01 to 20 μm. The oligomer blocking layer or the adhesion facilitating layer is often formed by an application method using a coater or by spraying, spin coating, or inline coating. Alternatively, the oligomer blocking layer or the adhesion facilitating layer may be formed using vacuum deposition, sputtering, ion plating, spray pyrolysis, chemical plating, electroplating, or other techniques. The coating process may be performed using a resin such as a polyvinyl alcohol resin, an acrylic resin, a urethane resin, a melamine resin, a UV-curable resin, or an epoxy resin, or a mixture of such a resin and inorganic particles such as alumina, silica, or mica particles. Alternatively, two or more layers of polymer substrates may be co-extruded so that the substrate component can function as the blocking layer. Alternatively, vacuum deposition, sputtering, ion plating, spray pyrolysis, chemical plating, electroplating, or other techniques may be performed using a metal such as gold, silver, platinum, palladium, copper, aluminum, nickel, chromium, titanium, iron, cobalt, tin, or any alloy thereof, a metal oxide such as indium oxide, tin oxide, titanium oxide, cadmium oxide, or any mixture thereof, or other metal compounds such as steel iodide.

Among the materials listed above for forming the oligomer blocking layer or the adhesion facilitating layer, a polyvinyl alcohol resin has a high oligomer-blocking function and is particularly advantageous in applications of the present invention. In general, such a polyvinyl alcohol resin preferably includes 30 to 100% by weight of polyvinyl alcohol as a main component. When the polyvinyl alcohol content is 30% by weight or more, a high oligomer precipitation-preventing effect can be obtained. Polyvinyl alcohol may be mixed with a water-borne resin such as polyester or polyurethane for imparting the adhesion facilitating properties. In general, the degree of polymerization of polyvinyl alcohol is preferably, but not limited to, 300 to 4,000 for applications. In general, the degree of saponification of polyvinyl alcohol is preferably, but not limited to, 70% by mole or more or 99.9% by mole or more. The polyvinyl alcohol resin may be used in combination with a crosslinking agent. Examples of the crosslinking agent include methylolated or alkylolated urea compounds, melamine compounds, guanamine compounds, acrylamide compounds, polyamide compounds, or various other compounds, epoxy compounds, aziridine compounds, blocked isocyanates, silane coupling agents, titanium coupling agents, and zirco-aluminate coupling agents. Any of these crosslinking components may be bonded to a binder polymer in advance. In order to improve binding or lubricating properties, inorganic particles may also be added, examples of which include silica, alumina, kaolin, calcium carbonate, titanium oxide, and barium salt particles. If necessary, an antifoaming agent, an application conditioner, a thickener, an organic lubricant, organic polymer particles, an antioxidant, an ultraviolet absorber, a foaming agent, a dye, or any other additive may also be added.

The transparent conductive layer of the transparent conductive laminated film obtained as described above may be subjected to the step of heat treating for crystallization (step (d)). Even when the heat treatment is performed, undulation can be kept small in the transparent conductive laminated film of the present invention because the plurality of transparent film substrates including the first and second film substrates are laminated with the transparent cured adhesive layer having the specified storage modulus in the laminated film.

The heating temperature for the crystallization is generally from about 60 to about 200° C., preferably from 100 to 150° C. The heat treatment time may be from 5 to 250 minutes. From these points of view, the film substrates such as the first and second film substrates preferably have resistance to heat at 100° C. or higher, more preferably resistance to heat at 140° C. or higher, for the heat treatment to be performed.

If the crystallization step (d) is performed after the step (e) of patterning the transparent conductive layer, the transparent conductive laminated film will tend to undulate more. Therefore, the crystallization step (d) is preferably performed before the patterning step (e). When the undercoat layer is subjected to etching, the crystallization step (d) is preferably performed after the etching of the undercoat layer.

The transparent conductive layer of the transparent conductive laminated film obtained as described above may be subjected to patterning (step (e)). In the patterning step (e), the transparent conductive layer may be patterned by etching. The etching process may include covering the transparent conductive layer with a patterning mask and etching the transparent conductive layer with an etching solution. The etching process may be followed by drying by heating. Even when drying by heating is performed, undulation can be kept small in the transparent conductive laminated film of the present invention because the plurality of transparent film substrates including the first and second film substrates are laminated with the transparent cured adhesive layer having the specified storage modulus in the laminated film.

Since the compounds listed above are preferably used for the transparent conductive layer, an acid is preferably used for the etching solution. Examples of the acid include inorganic acids such as hydrogen chloride, hydrogen bromide, sulfuric acid, nitric acid, and phosphoric acid, organic acids such as acetic acid, any mixtures thereof, and aqueous solutions thereof.

When at least two undercoat layers are provided, only the transparent conductive layer may be patterned by etching, or at least the undercoat layer most distant from the film substrate may be patterned by etching in the same way as for the transparent conductive layer after the transparent conductive layer is patterned by etching with an acid. Preferably, transparent conductive layers other than the undercoat layer located first from the film substrate may be patterned by etching in the same way as for the transparent conductive layer.

The process of etching the undercoat layer may include covering the undercoat layer with a patterning mask similar to that for the etching of the transparent conductive layer and etching the undercoat layer with an etching solution. As mentioned above, an inorganic material such as SiO₂ is preferably used to form an undercoat layer above the second layer. An alkali is preferably used as an etching solution for such an undercoat layer. Examples of the alkali include an aqueous solution of sodium hydroxide, potassium hydroxide, ammonia, or tetramethyl ammonium hydroxide and any mixtures thereof. In this regard, the first transparent conductive layer is preferably made of an organic material resistant to etching with acid or alkali.

The transparent conductive laminated film of the present invention can be used for, for example, an electrode substrate of an input device for capacitive touch panels. The capacitive touch panels may be multi-touch panels, in which the transparent conductive laminated film of the present invention can be used as part of the electrode substrate.

### EXAMPLES

Hereinafter, examples of the present invention will be described, which, however, should not be construed as limiting the embodiments of the present invention.

<Active Energy Rays>

The source of active energy rays used was an ultraviolet irradiator (gallium-containing metal halide lamp) Light Hammer 10 manufactured by Fusion UV Systems Inc. (valve, V valve; peak illuminance, 1,600 mW/cm²; total dose, 1,000/mJ/cm²; wavelength, 380-440 nm). The illuminance of the ultraviolet rays was measured with Sola-Check System manufactured by Solatell Ltd.

<Each Layer Thickness>

The thickness of each of the film substrates and the adhesive layer was measured with a thickness meter (Digital Dial Gauge DG-205 manufactured by Peacock). When it was difficult to directly measure the thickness, the total thickness of the substrate and each layer provided thereon was measured, and then the thickness of each layer was calculated by subtracting the thickness of the substrate from the measurement.

(Preparation of Active Energy Ray-Curable Adhesive Compositions)

According to the formulation shown in Table 2, each set of components were mixed and stirred at 50° C. for 1 hour to form each active energy ray-curable adhesive composition. In the table, each value indicates the content in units of % by weight based on 100% by weight of the total amount of the composition. Each component used is as follows.

(1) Radically polymerizable compound (A): Hydroxyethylacrylamide (HEAA), 29.6 in SP value, manufactured by KOHJIN Film & Chemicals Co., Ltd.

(2) Radically polymerizable compound (B): ARONIX M-220 (tripropylene glycol diacrylate), 19.0 in SP value, manufactured by Toagosei Co., Ltd.

Radically polymerizable compound (B): LIGHT ACRYLATE DCP-A (dimethylol tricyclodecane diacrylate), 20.3 in SP value, manufactured by Kyoeisha Chemical Co., Ltd.

(3) Radically polymerizable compound (C): Acryloylmorpholine (ACMO), 22.9 in SP value, manufactured by KOHJIN Film & Chemicals Co., Ltd.

Radically polymerizable compound (C): IB-XA (isobornyl acrylate), 22.4 in SP value, manufactured by Kyoeisha Chemical Co., Ltd.

(4) Acrylic oligomer (D) formed by polymerization of a (meth)acrylic monomer: ARUFON UP-1190 manufactured by Toagosei Co., Ltd.

(5) Radically polymerizable compound (E): 2-hydroxyethyl acrylate (2HEA), 25.5 in SP value, MITSUBISHI RAYON CO., LTD.

(6) Photopolymerization initiator: KAYACURE DETX-S (diethyl thioxanthone) manufactured by Nippon Kayaku Co., Ltd.; IRGACURE 907 (2-methyl-1-(4-methylthiophenyl)-2-morpholinopropan-1-one), manufactured by BASF

(7) Radically polymerizable compound (F) having an active methylene group

2-acetoacetoxyethyl methacrylate (AAEM), 20.23 (kJ/m³)^{1/2} in SP value, capable of forming a homopolymer with a Tg of 9° C., manufactured by The Nippon Synthetic Chemical Industry Co., Ltd.

(8) Radical polymerization initiator (G) having a hydrogen-withdrawing function

KAYACURE DETX-S (DETX-S) (diethyl thioxanthone) manufactured by Nippon Kayaku Co., Ltd.

(9) Photopolymerization initiator (compound of formula (2))

IRGACURE 907 (IRG907) (2-methyl-1-(4-methylthiophenyl)-2-morpholinopropan-1-one), manufactured by BASF

(10) Photo-acid generator (H)

CPI-100P (a propylene carbonate solution containing 50% of active components including triarylsulfonium hexafluorophosphate as a main component) manufactured by SAN-APRO LTD.

(11) Compound (I) containing either an alkoxy group or an epoxy group

DENACOL EX-611 (sorbitol polyglycidyl ether) manufactured by Nagase ChemteX Corporation

Nicaresin S-260 (methylolated melamine) manufactured by NIPPON CARBIDE INDUSTRIES CO., INC.

KBM-5103 (3-acryloxypropyltrimethoxysilane) manufactured by Shin-Etsu Chemical Co., Ltd.

(12) Amino group-containing silane coupling agent (J)

KBM-603 (γ-(2-aminoethyl)aminopropyltrimethoxysilane) manufactured by Shin-Etsu Chemical Co., Ltd.

KBM-602 (γ-(2-aminoethyl)aminopropylmethyldimethoxysilane) manufactured by Shin-Etsu Chemical Co., Ltd.

KBE-9103 (3-triethoxysilyl-N-(1,3-dimethylbutylidene)propylamine) manufactured by Shin-Etsu Chemical Co., Ltd.

### Example 1

### Formation of First Transparent Conductive Layer

A 22-nm-thick indium tin oxide (ITO) layer was formed on one surface of a 25-μm-thick polyethylene terephthalate film (first film substrate) using a sputtering system having a sintered target of indium tin oxide composed of 97% by weight of indium oxide and 3% by weight of tin oxide.

(Preparation of Transparent Conductive Laminated Film)

Subsequently, the active energy ray-curable adhesive composition prepared according to the formulation shown in FIG. 2 was applied to the surface of the polyethylene terephthalate film (first film substrate), opposite to the indium tin oxide layer, using an MCD coater (manufactured by FUJI KIKAI KOGYO Co., Ltd; cell shape, honeycomb; the number of gravure roll lines, 300/inch; rotational speed, 150% relative to line speed), so that a 1-μm-thick transparent uncured adhesive layer was formed. Subsequently, a 100-μm-thick polyethylene terephthalate film (second film substrate) was bonded to the uncured adhesive layer. The adhesive layer was then cured by irradiation from the second film substrate side using an irradiator Light Hammer 10 manufactured by Fusion UV Systems Inc. (valve, V valve; peak illuminance, 1, 600 mW/cm²; total dose, 1,000/mJ/cm²; wavelength, 380-440 nm), so that a transparent conductive laminated film was obtained.

### Examples 2 to 16 and Comparative Examples 1 and 2

Transparent conductive laminated films were prepared as in Example 1, except that the thickness of the first and second film substrates, the proportion of components in the active energy ray-curable adhesive composition, and the thickness of the adhesive layer were changed as shown in Tables 2 and 3. In Example 9, a 22-nm-thick second transparent conductive layer was also formed on the second film substrate in the same way as on the first film substrate, and the resulting laminate was used. In the preparation of the transparent conductive laminated film, the uncured adhesive layer was bonded to the surface of the second film substrate opposite to its surface on which the second transparent conductive layer was formed.

<Evaluation>

The transparent conductive laminated films obtained in the examples and the comparative examples were evaluated as described below. Tables 2 and 3 show the results. Tables 2 and 3 also show the thicknesses of the film substrates and the adhesive layer.

<<Storage Modulus>>

The storage modulus was measured with a dynamic viscoelastometer RSA-III manufactured by TA Instruments under the following conditions: sample size, 10 mm wide, 30 mm long; clamp distance, 20 mm; measurement mode, tensile mode; frequency, 1 Hz; rate of temperature rise, 5° C./minute. The dynamic viscoelasticity was measured, in which the storage modulus at 140° C. was determined.

<<Adhering Strength>>

A piece was cut from each transparent conductive laminated film. The cut piece had a length of 200 mm parallel to the stretched direction of the first film substrate and a width of 20 mm perpendicular thereto. In the cut piece of the transparent conductive film, an incision was then made between the first and second film substrates with a cutter knife. Using a Tensilon tester, the peel strength between the first and second films was measured at a peel rate of 300 mm/minute in T peel mode. The infrared absorption spectrum of the surface exposed by the peeling-off was also measured by ATR method, and the interface exposed by the peeling-off was evaluated based on the criteria below.

A: Cohesive failure of the film

B: Interfacial peeling between the film and the adhesive layer

As for the criteria, A means that the adhering strength is excellent because it is higher than the cohesive strength of the film. On the other hand, B means that the adhering strength at the interface between the film and the adhesive layer is insufficient (or the adhering strength is poor). Taking these into account, the adhering strength evaluated as A is rated as O (good), the adhering strength evaluated as A/B (“cohesive failure of the film” and “interfacial peeling between the film and the adhesive layer” occur simultaneously) is rated as Δ (fair), and the adhering strength evaluated as B only is rated as X (poor).

<<Water Resistance>>

Each transparent conductive laminated film was heat-treated at 140° C. for 90 minutes so that the transparent conductive layer (indium tin oxide layer) was crystallized. The transparent conductive layer was then removed by being immersed in a 10% hydrochloric acid aqueous solution at 50° C. for 10 minutes. During this process, whether and how peeling and lifting occurred at the edge of the transparent conductive laminated film was evaluated visually.

O: No peeling or lifting occurs.
Δ: Peeling or lifting occurs over a length of less than 1 mm.
X: Peeling or lifting occurs over a length of 1 mm or more.

<Undulation>

Each transparent conductive laminated film was heat-treated at 140° C. for 90 minutes so that the transparent conductive layer (indium tin oxide layer) was crystallized. A photoresist was then formed in a desired pattern on the surface of the first transparent conductive layer (on the first film substrate side). The first transparent conductive layer was then immersed in a 10% hydrochloric acid aqueous solution at 50° C. for 10 minutes, so that an unnecessary part of the first transparent conductive layer was removed. The product was then dried at 140° C. for 30 minutes, so that a stripe-patterned transparent electrode was obtained (etching process). An evaluation was performed of the undulation (height difference μm) between parts with and without the pattered transparent electrode in the resulting transparent conductive laminated film. The undulation (height difference μm) was measured with an optical profilometer (Optical Profilometer NT3000 manufactured by Veeco Instruments Inc.).

<Shrinkage Rate>

Pieces with a size of 10 cm×10 cm were cut from each transparent conductive laminated film and then marked at the four corners. The cut pieces were then heat-treated at 140° C. for 90 minutes so that the transparent conductive layer (indium tin oxide layer) was crystallized. Subsequently, samples 1 and 2 were prepared, in which the sample 1 was the cut piece with the entire surface of the transparent conductive layer (the first transparent conductive layer or both the first and second transparent conductive layers in Example 9) covered with a polyimide tape, and the sample 2 was the cut piece not covered with any polyimide tape.

Subsequently, the samples 1 and 2 were immersed in 10% hydrochloric acid. The transparent conductive layer was removed from the sample 2 (the product corresponded to the laminated film A′). After the immersion, the polyimide tape was removed from the sample 1 (the product corresponded to the transparent conductive laminated film A). At this point, the sizes of the samples 1 and 2 were precisely measured (before the treatment). Subsequently, after the samples 1 and 2 were dried at 140° C. for 30 minutes, the sizes of the samples 1 and 2 were measured again (after the treatment).

The shrinkage rate was calculated from the formula below using the sizes before and after the treatment.

Shrinkage rate (%)={(the size before the treatment−the size after the treatment)/(the size before the treatment)}×100

The shrinkage rate difference is the value obtained by subtracting the shrinkage rate of the sample 2 from the shrinkage rate of the sample 1.

The size of each of the samples 1 and 2 was measured with a vision measuring system Quick Vision (manufactured by Mitutoyo Corporation).

TABLE 2

| | | | | | Example | Example | Example | Example | Example |
|---|---|---|---|---|---|---|---|---|---|
| | | | | | 1 | 2 | 3 | 4 | 5 |
| First film substrate thickness (μm) | | | | | 25 | 25 | 25 | 25 | 25 |
| Second film substrate thickness (μm) | | | | | 100 | 100 | 100 | 100 | 100 |
| Active | Radically | (A)HEAA | SP | 29.6 | 10.0 | 10.0 | 10.0 | 10.0 | 10.0 |
| energy | polymerizable | (B)ARONIX M-220 | value | 19 | 70.0 | 40.0 | 55.0 | 78.0 | 72.0 |
| ray-curable | compound | (B)LIGHT ACRYLATE DCP-A | | 20.3 | — | 30.0 | — | — | — |
| adhesive | | (C)ACMO | | 22.9 | 10.0 | 10.0 | 10.0 | 10.0 | 10.0 |
| composition | | (C)IB-XA | | 22.4 | — | — | 15.0 | — | — |
| (wt %) | | (E)2HEA | | 25.5 | — | — | — | — | 3.0 |
| | | (F)AAEM | | 202 | — | — | — | — | — |

| | | | | | |
|---|---|---|---|---|---|
| (I)DENACOL EX-611 | — | — | — | — | — |
| (I)Nicaresin S-260 | — | — | — | — | — |
| (I)KBM-5103 | — | — | — | — | — |
| (J)KBM-603 | — | — | — | — | — |
| (J)KBM-602 | — | — | — | — | — |
| (J)KBE-9103 | — | — | — | — | — |

| | | | | | | |
|---|---|---|---|---|---|---|
| Acrylic oligomer | (D)ARUFON UP1190 | 8.0 | 8.0 | 8.0 | — | 3.0 |
| Photopolymerization | (G)KAYACURE DETX-S | 0.5 | 0.5 | 0.5 | 0.5 | 0.5 |
| initiator | IRGACURE 907 | 1.5 | 1.5 | 1.5 | 1.5 | 1.5 |
| | (H)CPI-100P | — | — | — | — | — |

| | | | | | | |
|---|---|---|---|---|---|---|
| Adhesive layer | Storage modulus (Pa) at 140° C. | 3.7 × 10⁷ | 4.0 × 10⁷ | 2.0 × 10⁷ | 8.9 × 10⁷ | 4.1 × 10⁷ |
| | Thickness (μm) | 0.9 | 1.2 | 1.0 | 0.8 | 0.9 |
| | First film substrate adhering strength | 2.5 | 3.8 | 4.2 | 1.2 | 2.8 |
| | | ∘ | ∘ | ∘ | Δ | ∘ |
| Evaluation | | (A) | (A) | (A) | (A · B) | (A) |
| | Water resistance | ∘ | ∘ | ∘ | ∘ | ∘ |
| | Undulation (height difference μm) | 0.7 | 0.5 | 0.9 | 0.3 | 0.7 |
| | Shrinkage rate difference (%) | 0.05 | 0.03 | 0.03 | 0.03 | 0.05 |

| | | | | | Example | Example | Example | Example |
|---|---|---|---|---|---|---|---|---|
| | | | | | 6 | 7 | 8 | 9 |
| First film substrate thickness (μm) | | | | | 25 | 25 | 50 | 50 |
| Second film substrate thickness (μm) | | | | | 100 | 75 | 100 | 50 |
| Active | Radically | (A)HEAA | SP | 29.6 | 5.0 | 5.0 | 5.0 | 5.0 |
| energy | polymerizable | (B)ARONIX M-220 | value | 19 | 68.0 | 68.0 | 68.0 | 68.0 |
| ray-curable | compound | (B)LIGHT ACRYLATE DCP-A | | 20.3 | 10.0 | 10.0 | 10.0 | 10.0 |
| adhesive | | (C)ACMO | | 22.9 | 10.0 | 10.0 | 10.0 | 10.0 |
| composition | | (C)IB-XA | | 22.4 | — | — | — | — |
| (wt %) | | (E)2HEA | | 25.5 | — | — | — | — |
| | | (F)AAEM | | 202 | — | — | — | — |

| | | | | |
|---|---|---|---|---|
| (I)DENACOL EX-611 | — | — | — | — |
| (I)Nicaresin S-260 | — | — | — | — |
| (I)KBM-5103 | — | — | — | — |
| (J)KBM-603 | — | — | — | — |
| (J)KBM-602 | — | — | — | — |
| (J)KBE-9103 | — | — | — | — |

| | | | | | |
|---|---|---|---|---|---|
| Acrylic oligomer | (D)ARUFON UP1190 | 5.0 | 5.0 | 5.0 | 5.0 |
| Photopolymerization | (G)KAYACURE DETX-S | 0.5 | 0.5 | 0.5 | 0.5 |
| initiator | IRGACURE 907 | 1.5 | 1.5 | 1.5 | 1.5 |
| | (H)CPI-100P | — | — | — | — |

| | | | | | |
|---|---|---|---|---|---|
| Adhesive layer | Storage modulus (Pa) at 140° C. | 6.3 × 10⁷ | 6.3 × 10⁷ | 6.3 × 10⁷ | 6.3 × 10⁷ |
| | Thickness (μm) | 5.0 | 1.1 | 1.2 | 1.2 |
| | First film substrate adhering strength | 1.7 | 3.8 | 4.2 | 5.5 |
| | | Δ | ∘ | ∘ | ∘ |
| Evaluation | | (A · B) | (A) | (A) | (A) |
| | Water resistance | ∘ | ∘ | ∘ | ∘ |
| | Undulation (height difference μm) | 0.4 | 0.9 | 0.2 | 0.8 |
| | Shrinkage rate difference (%) | 0.03 | 0.06 | 0.01 | 0.08 |

TABLE 3

| | | | | | Example | Example | Example | Example | Example |
|---|---|---|---|---|---|---|---|---|---|
| | | | | | 10 | 11 | 12 | 13 | 14 |
| First film substrate thickness (μm) | | | | | 25 | 25 | 25 | 25 | 25 |
| Second film substrate thickness (μm) | | | | | 100 | 100 | 100 | 100 | 100 |
| Active | Radically | (A)HEAA | SP | 29.6 | — | — | — | — | — |
| energy | polymerizable | (B)ARONIX M-220 | value | 19 | 20.0 | 210 | 20.0 | 20.0 | 20.0 |
| ray-curable | compound | (B)LIGHT ACRYLATE DCP-A | | 20.3 | 30.0 | 30.0 | 30.0 | 30.0 | 30.0 |
| adhesive | | (C)ACMO | | 22.9 | 30.0 | 30.0 | 30.0 | 30.0 | 30.0 |
| composition | | (C)IB-XA | | 22.4 | 10.0 | 10.0 | 10.0 | 10.0 | 12.0 |
| (wt %) | | (E)2HEA | | 25.5 | — | — | — | — | — |
| | | (F)AAEM | | 20.2 | 8.0 | — | — | — | — |

| | | | | | |
|---|---|---|---|---|---|
| (I)DENACOL EX-611 | — | 5.0 | — | — | — |
| (I)Nicaresin S-260 | — | — | 5.0 | — | — |
| (I)KBM-5103 | — | — | — | 5.0 | — |
| (J)KBM-603 | — | — | — | — | 3.0 |
| (J)KBM-602 | — | — | — | — | — |
| (J)KBE-9103 | — | — | — | — | — |

| | | | | | | |
|---|---|---|---|---|---|---|
| Acrylic oligomer | (D)ARUFON UP1190 | — | — | — | — | — |
| Photopolymerization | (G)KAYACURE DBTX-S | 0.5 | 0.5 | 0.5 | 0.5 | 0.5 |
| initiator | IRGACURE 907 | 1.5 | 1.5 | 1.5 | 1.5 | 1.5 |
| | (H)CPI-100P | — | 3.0 | 3.0 | 3.0 | 3.0 |

| | | | | | | |
|---|---|---|---|---|---|---|
| Adhesive layer | Storage modulus (Pa) at 140° C. | 5.4 × 10⁷ | 5.4 × 10⁷ | 5.4 × 10⁷ | 5.4 × 10⁷ | 5.4 × 10⁷ |
| | Thickness (μm) | 1.0 | 1.0 | 1.0 | 1.0 | 1.0 |
| Evaluation | First film substrate adhering strength | 3.5 | 3.9 | 4.3 | 2.5 | 4.5 |
| | | ∘ | ∘ | ∘ | ∘ | ∘ |
| | | (A) | (A) | (A) | (A) | (A) |
| | Water resistance | ∘ | ∘ | ∘ | ∘ | ∘ |
| | Undulation (height difference μm) | 0.4 | 0.5 | 0.3 | 0.7 | 0.6 |
| | Shrinkage rate difference (%) | 0.05 | 0.03 | 0.06 | 0.04 | 0.05 |

| | | | | | Example | Example | Comparative | Comparative |
|---|---|---|---|---|---|---|---|---|
| | | | | | 15 | 16 | Example 1 | Example 2 |
| First film substrate thickness (μm) | | | | | 25 | 25 | 25 | 25 |
| Second film substrate thickness (μm) | | | | | 100 | 100 | 100 | 100 |
| Active | Radically | (A)HEAA | SP | 29.6 | — | — | 10.0 | 10.0 |
| energy | polymerizable | (B)ARONIX M-220 | value | 19 | 20.0 | 20.0 | 10.0 | 18.0 |
| ray-curable | compound | (B)LIGHT ACRYLATE DCP-A | | 20.3 | 30.0 | 30.0 | — | — |
| adhesive | | (C)ACMO | | 22.9 | 30.0 | 30.0 | 10.0 | 10.0 |
| composition | | (C)IB-XA | | 22.4 | 12.0 | 12.0 | — | — |
| (wt %) | | (E)2HEA | | 25.5 | — | — | 50.0 | — |
| | | (F)AAEM | | 20.2 | — | — | — | — |

| | | | | |
|---|---|---|---|---|
| (I)DENACOL EX-611 | — | — | — | — |
| (I)Nicaresin S-260 | — | — | — | — |
| (I)KBM-5103 | — | — | — | — |
| (J)KBM-603 | — | — | — | — |
| (J)KBM-602 | 3.0 | — | — | — |
| (J)KBE-9103 | — | 3.0 | — | — |

| | | | | | |
|---|---|---|---|---|---|
| Acrylic oligomer | (D)ARUFON UP1190 | — | — | 18.0 | 60.0 |
| Photopolymerization | (G)KAYACURE DBTX-S | 0.5 | 0.5 | 0.5 | 0.5 |
| initiator | IRGACURE 907 | 1.5 | 1.5 | 1.5 | 1.5 |
| | (H)CPI-100P | 3.0 | 3.0 | — | — |

| | | | | | |
|---|---|---|---|---|---|
| Adhesive layer | Storage modulus (Pa) at 140° C. | 5.4 × 10⁷ | 5.4 × 10⁷ | 2.3 × 10⁶ | 5.2 × 10⁵ |
| | Thickness (μm) | 1.0 | 1.0 | 0.8 | 1.5 |
| Evaluation | First film substrate adhering strength | 4.2 | 4.8 | 3.5 | 4.1 |
| | | ∘ | ∘ | x | x |
| | | (A) | (A) | (B) | (B) |
| | Water resistance | ∘ | ∘ | x | Δ |
| | Undulation (height difference μm) | 0.6 | 0.6 | 2.3 | 5.2 |
| | Shrinkage rate difference (%) | 0.05 | 0.05 | 0.45 | 0.39 |

### DESCRIPTION OF REFERENCE SIGNS

In the drawings, reference sign 11 represents a first film substrate, 12 a second film substrate, 13 a third film substrate, 21 a first transparent conductive layer, 22 a second transparent conductive layer, 3 a transparent cured adhesive layer, A a transparent conductive laminated film, and A′ a laminated film.

### DESCRIPTION OF REFERENCE SIGNS

11 first transparent film substrate
12 second transparent film substrate
13 third transparent film substrate
21 first transparent conductive layer
22 second transparent conductive layer
3 transparent cured adhesive layer
A transparent conductive laminated film
A′ laminated film

1. A transparent conductive laminated film, comprising:
a laminated film comprising a plurality of transparent film substrates and a transparent cured adhesive layer having a storage modulus of 1×10⁷ Pa or more at 140° C., wherein the plurality of transparent film substrates include a first transparent film substrate and a second transparent film substrate and are laminated with the transparent cured adhesive layer interposed between adjacent ones of the film substrates; and
a first transparent conductive layer provided on a surface of the first film substrate opposite to the transparent cured adhesive layer.

2. The transparent conductive laminated film according to claim 1, wherein there is a difference in shrinkage rate of 0.3% or less between the transparent conductive laminated film and the laminated film after the film is heat-treated at 140° C. for 30 minutes.

3. The transparent conductive laminated film according to claim 1, wherein the transparent cured adhesive layer is made from an active energy ray-curable adhesive composition comprising, as curable components, (A) a radically polymerizable compound with an SP value of 29.0 (kJ/m³)^{1/2} to 32.0 (kJ/m³)^{1/2}, (B) a radically polymerizable compound with an SP value of 18.0 (kJ/m³)^{1/2} to less than 21.0 (kJ/m³)^{1/2}, and (C) a radically polymerizable compound with an SP value of 21.0 (kJ/m³)^{1/2} to 23.0 (kJ/m³)^{1/2}, wherein the content of the radically polymerizable compound (B) is from 25 to 80% by weight based on 100% by weight of the total amount of the composition.

4. The transparent conductive laminated film according to claim 3, wherein the active energy ray-curable adhesive composition further comprises (D) an acrylic oligomer formed by polymerization of a (meth)acrylic monomer.

5. The transparent conductive laminated film according to claim 4, wherein the active energy ray-curable composition contains 20% by weight or less of the acrylic oligomer (D) formed by polymerization of a (meth)acrylic monomer based on 100% by weight of the total amount of the composition.

6. The transparent conductive laminated film according to claim 3, wherein the active energy ray-curable adhesive composition contains 3 to 40% by weight of the radically polymerizable compound (A) and 5 to 55% by weight of the radically polymerizable compound (C) based on 100% by weight of the total amount of the composition.

7. The transparent conductive laminated film according to claim 3, wherein the active energy ray-curable adhesive composition comprises the radically polymerizable compounds (A), (B), and (C) in a total amount of 85 parts by weight or more and further comprises 15 parts by weight or less of (E) a radically polymerizable compound with an SP value of more than 23.0 (kJ/m³)^{1/2} to less than 29.0 (kJ/m³)^{1/2} based on 100 parts by weight of the total amount of the radically polymerizable compounds.

8. The transparent conductive laminated film according to claim 1, wherein the active energy ray-curable adhesive composition further comprises (F) a radically polymerizable compound having an active methylene group and (G) a radical polymerization initiator having a hydrogen-withdrawing function.

9. The transparent conductive laminated film according to claim 8, wherein the active methylene group is an acetoacetyl group.

10. The transparent conductive laminated film according to claim 8, wherein the radically polymerizable compound (F) having an active methylene group is acetoacetoxyalkyl(meth)acrylate.

11. The transparent conductive laminated film according to claim 8, wherein the radical polymerization initiator (F) is a thioxanthone radical polymerization initiator.

12. The transparent conductive laminated film according to claim 8, wherein the active energy ray-curable adhesive composition contains 1 to 50% by weight of the radically polymerizable compound (F) having an active methylene group and 0.1 to 10% by weight of the radical polymerization initiator (G) based on 100% by weight of the total amount of the composition.

13. The transparent conductive laminated film according to claim 1, wherein the active energy ray-curable adhesive composition further comprises (H) a photo-acid generator.

14. The transparent conductive laminated film according to claim 13, wherein the photo-acid generator (H) includes a photo-acid generator having at least one counter anion selected from the group consisting of PF₆⁻, SbF₆⁻, and AsF₆⁻.

15. The transparent conductive laminated film according to claim 1, wherein the active energy ray-curable adhesive composition further comprises (I) a compound having either an alkoxy group or an epoxy group in addition to the photo-acid generator (H).

16. The transparent conductive laminated film according to claim 1, wherein the active energy ray-curable adhesive composition further comprises (J) an amino group-containing silane coupling agent.

17. The transparent conductive laminated film according to claim 16, wherein the active energy ray-curable adhesive composition contains 0.01 to 20% by weight of the amino group-containing silane coupling agent (J) based on 100% by weight of the total amount of the composition.

18. The transparent conductive laminated film according to claim 1, wherein the first film substrate has a thickness of 15 μm to 75 μm.

19. The transparent conductive laminated film according to claim 1, wherein the transparent cured adhesive layer has a thickness of 0.01 μm to 10 μm.

20. The transparent conductive laminated film according to claim 1, further comprising a second transparent conductive layer on a surface of the laminated film opposite to the first transparent conductive layer.

21. The transparent conductive laminated film according to claim 1, wherein the film substrates are made of any one of a polyester resin, a cyclic polyolefin resin, or a polycarbonate resin.

22. The transparent conductive laminated film according to claim 1, wherein the transparent conductive layer is made of any one of indium tin oxide or indium zinc oxide.

23. The transparent conductive laminated film according to claim 1, wherein the transparent conductive layer is crystallized.

24. The transparent conductive laminated film according to claim 1, wherein the transparent conductive layer is patterned.

25. A touch panel comprising at least one piece of the transparent conductive laminated film according to claim 1.

26. A method for producing the transparent conductive laminated film according to claim 1, the method comprising the steps of:
(a) preparing a transparent conductive film comprising a first film substrate and a first transparent conductive layer provided on one surface of the first film substrate;
(b) bonding a second film substrate to another surface of the first film substrate with a transparent uncured adhesive layer, wherein the another surface of the first film substrate is opposite to the surface on which the first transparent conductive layer is provided, and the transparent uncured adhesive layer is capable of forming a transparent cured adhesive layer having a storage modulus of 1×10⁷ Pa or more at 140° C. when cured; and
(c) curing the transparent uncured adhesive layer.

27. The method according to claim 26, further comprising the step (d) of heat-treating the transparent conductive layer to crystallize the transparent conductive layer after the step (c).

28. The method according to claim 26, further comprising the step (e) of patterning the transparent conductive layer after the step (c).

29. The method according to claim 26, wherein the step (c) comprises irradiating the transparent uncured adhesive layer with active energy rays to cure the transparent uncured adhesive layer, wherein the active energy rays include visible rays with a wavelength in the range of 380 nm to 450 nm.

30. The method according to claim 29, wherein the active energy rays are such that the ratio of the total illuminance in the wavelength range of 380 nm to 440 nm to the total illuminance in the wavelength range of 250 nm to 370 nm is from 100:0 to 100:50.
